(19) United States
(12) Patent Application Publication
(10) Pub. No.: US 2026/0343691 A1
(43) Pub. Date: Oct. 29, 2026

(54) HOME APPLIANCE AND METHOD FOR CONTROLLING THE SAME

(71) Applicant: Samsung Electronics Co., Ltd., Suwon-si (KR)

(72) Inventors: Jaeyong CHO, Suwon-si (KR); Sewon GWON, Suwon-si (KR); Hyungjun AN, Suwon-si (KR); Sungbum PARK, Suwon-si (KR); Daehyun KIM, Suwon-si (KR)

(21) Appl. No.: 19/653,803

(22) Filed: Apr. 21, 2026

Related U.S. Application Data
(63) Continuation of application No. PCT/KR2026/095221, filed on Mar. 24, 2026.

(30) Foreign Application Priority Data
Apr. 24, 2025 (KR) 10-2025-0054002
Aug. 4, 2025 (KR) 10-2025-0107097

(51) Int. Cl. H05B 6/50; H05B 1/02; H05B 6/54; H05B 6/62

(52) U.S. Cl. CPC H05B 6/50; H05B 1/0263; H05B 1/0272; H05B 6/54; H05B 6/62

(57) ABSTRACT

A home appliance is provided. The home appliance includes a first electrode, a second electrode spaced apart from the first electrode, a radio frequency (RF) power supplier configured to apply an RF signal to the first electrode and the second electrode, a voltage-current sensor configured to detect an output voltage between the first electrode and the second electrode and an output current of the first electrode, an impedance matching circuit configured to perform impedance matching between an output side of the RF power supplier and the first electrode and the second electrode, a reactance regulator disposed between the first electrode and the impedance matching circuit, and a controller configured to identify a load impedance between the first electrode and the second electrode based on the output voltage and the output current, determine a compensation reactance for removing a first reactance included in the load impedance, and control the reactance regulator to have a second reactance corresponding to the compensation reactance.

### CROSS-REFERENCE TO RELATED APPLICATION(S)

This application is a continuation application, claiming priority under 35 U.S.C. § 365(c), of an International application No. PCT/KR 2026/095221, filed on Mar. 24, 2026, which is based on and claims the benefit of a Korean patent application number 10-2025-0054002, filed on Apr. 24, 2025, in the Ministry of Intellectual Property (MOIP), and of a Korean patent application number 10-2025-0107097, filed on Aug. 4, 2025, in the Ministry of Intellectual Property (MOIP), the disclosure of each of which is incorporated by reference herein in its entirety.

### TECHNICAL FIELD

The disclosure relates to a home appliance that may heat an object using dielectric heating, and a method for controlling the home appliance.

### BACKGROUND ART

Home appliances capable of heating an object may include various types of devices. For example, the home appliance may include a dryer capable of drying clothes by removing moisture contained in the clothes, a cooking appliance (or defrosting appliance) capable of heating an object, and a refrigerator capable of storing an object in a non-frozen state even at sub-zero temperatures.

In existing technologies, an object was heated by supplying hot air to the object or by irradiating the object with microwaves. In the method of supplying hot air to the object, heat is transferred from air having a low specific heat to water having a high specific heat, resulting in low heat transfer efficiency and low heating efficiency. In addition, high-temperature air may damage the object.

In the method of irradiating the object with microwaves using a magnetron, a high frequency of 900 MHz or higher with a short wavelength is used. Accordingly, the microwaves may not penetrate into the object, and only the surface of the object is heated. Furthermore, the magnetron has a relatively large size, occupying a large space within the home appliance.

A home appliance that heats an object (e.g., clothes or an item) using dielectric heating heats the object placed between two electrodes using electromagnetic waves with a relatively long wavelength, which allows heat transfer to the inside of the object and enables uniform heating. In addition, because a circuit structure for dielectric heating is relatively small, space utilization of space within the home appliance may be improved.

To increase the heating efficiency of the object placed between the two electrodes, the object and the two electrodes require to be positioned as close as possible. As there is more empty space between the object and the two electrodes, the heating efficiency decreases. From an impedance perspective, increased empty space corresponds to an increased reactance. As there is more empty space between the two electrodes, the load impedance is detected to increase, and the actual impedance of the object may not be accurately detected. Accordingly, impedance matching may not be accurately performed, and maximum active power may not be transmitted to the object, and thus dielectric heating efficiency may decrease.

The above information is presented as background information only to assist with an understanding of the disclosure. No determination has been made, and no assertion is made, as to whether any of the above might be applicable as prior art with regard to the disclosure.

### DISCLOSURE

Aspects of the disclosure are to address at least the above-mentioned problems and/or disadvantages and to provide at least the advantages described below. Accordingly, an aspect of the disclosure is to provide a home appliance that may suppress a decrease in heating efficiency of an object due to an empty space between two electrodes by controlling a reactance regulator disposed between the electrodes and an impedance matching circuit, and a method for controlling the home appliance.

Another aspect of the disclosure is to provide a home appliance that is capable of delivering maximum active power to an object by reducing and/or removing a reactance component of a load impedance without physically adjusting a distance between two electrodes, and a method for controlling the home appliance.

Another aspect of the disclosure is to provide a home appliance that may relatively accurately measure an actual impedance of an object using a reactance regulator disposed between electrodes and an impedance matching circuit, and a method for controlling the home appliance.

Another aspect of the disclosure is to provide a home appliance that may reduce a voltage and a current applied to an electrode for heating an object by reducing and/or removing a reactance component of a load impedance.

Additional aspects will be set forth in part in the description which follows and, in part, will be apparent from the description, or may be learned by practice of the presented embodiments.

In accordance with an aspect of the disclosure, a home appliance is provided. The home appliance includes a first electrode, a second electrode spaced apart from the first electrode, a radio frequency (RF) power supplier configured to apply an RF signal to the first electrode and the second electrode, a voltage-current sensor configured to detect an output voltage between the first electrode and the second electrode and an output current of the first electrode, an impedance matching circuit configured to perform impedance matching between an output side of the RF power supplier and the first electrode and the second electrode, a reactance regulator disposed between the first electrode and the impedance matching circuit, and a controller configured to identify a load impedance between the first electrode and the second electrode based on the output voltage and the output current, determine a compensation reactance for removing a first reactance included in the load impedance, and control the reactance regulator to have a second reactance corresponding to the compensation reactance.

In accordance with another aspect of the disclosure, a method for controlling a home appliance including a first electrode, a second electrode spaced apart from the first electrode, a radio frequency (RF) power supplier configured to apply an RF signal to the first electrode and the second electrode, an impedance matching circuit configured to perform impedance matching between an output side of the RF power supplier and the first electrode and the second electrode, a reactance regulator disposed between the first electrode and the impedance matching circuit, a voltage-current sensor, and a controller is provided. The method includes detecting, by the voltage-current sensor, an output voltage between the first electrode and the second electrode and an output current of the first electrode, identifying, by the controller, a load impedance between the first electrode and the second electrode based on the output voltage and the output current, determining, by the controller, a compensation reactance for removing a first reactance included in the load impedance, and controlling, by the controller, the reactance regulator to have a second reactance corresponding to the compensation reactance.

In accordance with another aspect of the disclosure, one or more non-transitory computer-readable storage media storing one or more computer programs including computer-executable instructions that, when executed by one or more processors of a controller of a home appliance individually or collectively, cause the home appliance to perform operations are provided. The home appliance including a first electrode, a second electrode spaced apart from the first electrode, a radio frequency (RF) power supplier configured to apply an RF signal to the first electrode and the second electrode, an impedance matching circuit configured to perform impedance matching between an output side of the RF power supplier and the first electrode and the second electrode, a reactance regulator disposed between the first electrode and the impedance matching circuit, and a voltage-current sensor, the operations include detecting, by the voltage-current sensor, an output voltage between the first electrode and the second electrode and an output current of the first electrode, identifying, by the controller, a load impedance between the first electrode and the second electrode based on the output voltage and the output current, determining, by the controller, a compensation reactance for removing a first reactance included in the load impedance, and controlling, by the controller, the reactance regulator to have a second reactance corresponding to the compensation reactance.

According to the disclosure, the home appliance and the method for controlling the same suppress a decrease in heating efficiency of an object due to an empty space between two electrodes by controlling a reactance regulator disposed between the electrodes and an impedance matching circuit.

According to the disclosure, the home appliance and the method for controlling the same transmit a maximum active power to an object by reducing and/or removing a reactance component of a load impedance without physically adjusting a distance between two electrodes.

According to the disclosure, the home appliance and the method for controlling the same relatively accurately measure an actual impedance of an object using a reactance regulator disposed between electrodes and an impedance matching circuit.

According to the disclosure, the home appliance and the method for controlling the same reduce a voltage and a current applied to an electrode for heating an object by reducing and/or removing a reactance component of a load impedance. Accordingly, power consumption is reduced and stability of the circuit system is improved.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a diagram of a network system implemented by various electronic devices according to an embodiment of the disclosure;

FIG. 2 is a control block diagram of a home appliance according to an embodiment of the disclosure;

FIG. 3 illustrates an example of a circuit board including a circuit system for a heating operation of a home appliance according to an embodiment of the disclosure;

FIG. 4 is a block diagram of a circuit system for a heating operation of a home appliance according to an embodiment of the disclosure;

FIGS. 5 and 6 illustrate a detailed structure of the circuit system illustrated in FIG. 4 according to various embodiments of the disclosure;

FIG. 7 illustrates a modified example of the circuit system illustrated in FIG. 6 according to an embodiment of the disclosure;

FIG. 8 is a diagram illustrating load impedance corresponding to an object and an empty space between two electrodes according to an embodiment of the disclosure;

FIGS. 9, 10, and 11 illustrate reactance regulators according to various embodiments of the disclosure;

FIG. 12 is a flowchart illustrating a method for controlling a home appliance according to an embodiment of the disclosure;

FIG. 13 is a flowchart illustrating a method for controlling a home appliance according to an embodiment of the disclosure;

FIG. 14 illustrates a lookup table according to an embodiment of the disclosure;

FIG. 15 is a Smith chart illustrating an impedance matching method according to the related art;

FIG. 16 is a Smith chart illustrating an impedance matching method according to an embodiment of the disclosure;

FIG. 17 illustrates an apparatus corresponding to a dryer as a home appliance according to an embodiment of the disclosure;

FIG. 18 illustrates an arrangement structure of a drum and electrodes of the dryer illustrated in FIG. 17 according to an embodiment of the disclosure;

FIG. 19 illustrates an apparatus corresponding to a defrosting appliance or a refrigerator as a home appliance according to an embodiment of the disclosure; and

FIG. 20 illustrates an apparatus corresponding to a cooking appliance as a home appliance according to an embodiment of the disclosure.

Throughout the drawings, it should be noted that like reference numbers are used to depict the same or similar elements, features, and structures.

### MODES OF THE DISCLOSURE

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing of the drawings, similar reference numerals may be used for similar or related elements.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases. For example, the term “at least one of A, B, and C” may include A, B, C, a combination of A and B, a combination of A and C, a combination of B and C, or a combination of A, B and C.

The term “at least one” used herein includes any and all combinations of the associated listed items. For example, it is to be understood that the term “at least one of A, B, and C” may include only A, only B, only C, both A and B, both A and C, both B and C, or all of A, B and C. In another example, “at least one of A, B, or C,” may include only A, only B, only C, both A and B, both A and C, both B and C, or all of A, B and C.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, the principles of operation and embodiments of the disclosure will be described with reference to the accompanying drawings.

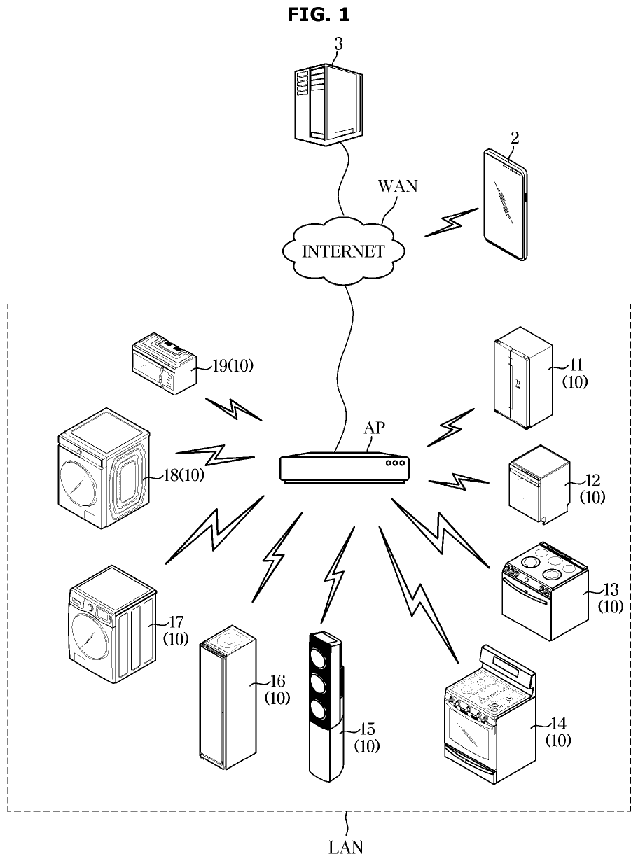

FIG. 1 is a diagram of a network system implemented by various electronic devices according to an embodiment of the disclosure.

Referring to FIG. 1, a home appliance 10 may include a communication module capable of communicating with another home appliance, a user device 2, or a server 3, a user interface that receives a user input or outputs information to a user, at least one processor that controls an operation of the home appliance 10, and memory that stores a program for controlling the operation of the home appliance 10.

The home appliance 10 may be at least one of various types of home appliances. For example, as shown in the accompanying drawings, the home appliance 10 may include a refrigerator 11, a dishwasher 12, an electric range 13, an electric oven 14, an air conditioner 15, a clothes treating apparatus 16, a washing machine 17, a dryer 18, and a microwave oven 19.

However, the home appliance 10 is not limited to those illustrated in FIG. 1. For example, the home appliance 10 may include various types of appliances not shown in the drawings, such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the home appliance 10 according to an embodiment.

The server 3 may include a communication module communicating with another server, the home appliance 10, or the user device 2, at least one processor that processes data received from another server, the home appliance 10, or the user device 2, and memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 10 in association with the user account, managing or controlling the registered home appliance 10, and the like. For example, a user may access the server 3 via the user device 2 and may create a user account. The user account may be identified by an identifier (ID) and a password set by the user. The server 3 may register the home appliance 10 with the user account according to a predetermined procedure. For example, the server 3 may link identification information of the home appliance 10 (e.g., a serial number or medium access control (MAC) address) to the user account to register, manage, and control the home appliance 10. The user device 2 may include a communication module capable of communicating with the home appliance 10 or the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program for controlling the home appliance 10, i.e. An application. The application may be sold installed on the user device 2, or may be downloaded from an external server for installation.

By running the application installed on the user device 2 by a user, the user may access the server 3, create a user account, and communicate with the server 3 based on the login user account to register the home appliance 10.

For example, by operating the home appliance 10 to allow the home appliance 10 to access the server 3 according to a procedure guided by the application installed on the user device 2, the server 3 may register the home appliance 10 with the user account by assigning the identification information (e.g., a serial number or a MAC address) of the home appliance 10 to the corresponding user account.

A user may control the home appliance 10 using the application installed on the user device 2. For example, by logging into a user account with the application installed on the user device 2, the home appliance 10 registered in the user account appears, and by inputting a control command for the home appliance 10, the control command may be delivered to the home appliance 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth™ (IEEE 802.15.1), Zigbee (IEEE 802.15.4), Wi-Fi Direct, near field communication (NFC), and Z-Wave, but is not limited thereto.

The AP may connect the home appliance 10 or the user device 2 to a WAN connected to the server 3. The home appliance 10 or the user device 2 may be connected to the server 3 via a WAN.

The AP may communicate with the home appliance 10 or the user device 2 using wireless communication, such as Wi-Fi™ (IEEE 802.11), Bluetooth™ (IEEE 802.15.1), Zigbee (IEEE 802.15.4), and the like, and access a WAN using wired communication, but is not limited thereto.

According to various embodiments, the home appliance 10 may be directly connected to the user device 2 or the server 3 without going through an AP.

The home appliance 10 may be connected to the user device 2 or the server 3 via a long-range wireless network or a short-range wireless network.

For example, the home appliance 10 may be connected to the user device 2 via a short-range wireless network (e.g., Wi-Fi Direct).

In another example, the home appliance 10 may be connected to the user device 2 or the server 3 via a WAN using a long-range wireless network (e.g., a cellular communication module).

In still another example, the home appliance 10 may access a WAN using wired communication, and may be connected to another home appliance 10 or the server 3 via a WAN.

When accessing a WAN using wired communication, the home appliance 10 may also act as an AP. Accordingly, the home appliance 10 may connect another home appliance 10 to a WAN to which the server 3 is connected. In addition, another home appliance 10 may connect the home appliance 10 to the WAN to which the server 3 is connected.

The home appliance 10 may transmit information about an operation or state to other home appliances, the user device 2, or the server 3 via the network. For example, the home appliance 10 may transmit information about an operation or state to other home appliances, the user device 2 or the server 3 upon receiving a request from the server 3, in response to an event in the home appliance 10, or periodically or in real time. Upon receiving the information about the operation or state from the home appliance 10, the server 3 may update the stored information about the operation or state of the home appliance 10 and transmit the updated information about the operation and state of the home appliance 10 to the user device 2 via the network. Updating the information may include various operations in which existing information is changed, such as adding new information to the existing information, replacing the existing information with new information, and the like.

The home appliance 10 may obtain various information from other home appliances, the user device 2, or the server 3, and may provide the obtained information to a user. For example, the home appliance 10 may obtain information related to a function of the home appliance 10 (e.g., recipes, washing instructions, etc.) from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the home appliance 10 may operate in accordance with a control command received from the server 3, based on a prior authorization obtained from a user to operate in accordance with the control command of the server 3 even without a user input. The control command received from the server 3 may include a control command input by the user via the user device 2 or a control command based on preset conditions, but is not limited thereto.

The user device 2 may transmit information about a user to the home appliance 10 or the server 3 via the communication module. For example, the user device 2 may transmit information about a user's location, a user's health condition (i.e., state), a user's preference, a user's schedule, and the like to the server 3. The user device 2 may transmit information about the user to the server 3 based on the user's prior authorization.

The home appliance 10, the user device 2, or the server 3 may use techniques, such as artificial intelligence (AI) to determine a control command. For example, the server 3 may receive information about an operation or a state of the home appliance 10 or information about a user of the user device 2, process the received information using techniques, such as AI, and transmit a processing result or a control command to the home appliance 10 or the user device 2 based on the processing result.

The home appliance 10 described below may correspond to the refrigerator 11, the electric range 13, the electric oven 14, the clothes treating apparatus 16, the washing machine 17, the dryer 18, or the microwave oven 19 described above. The electric range 13, the electric oven 14, and the microwave oven 19 may be examples of a cooking appliance or a defrosting appliance.

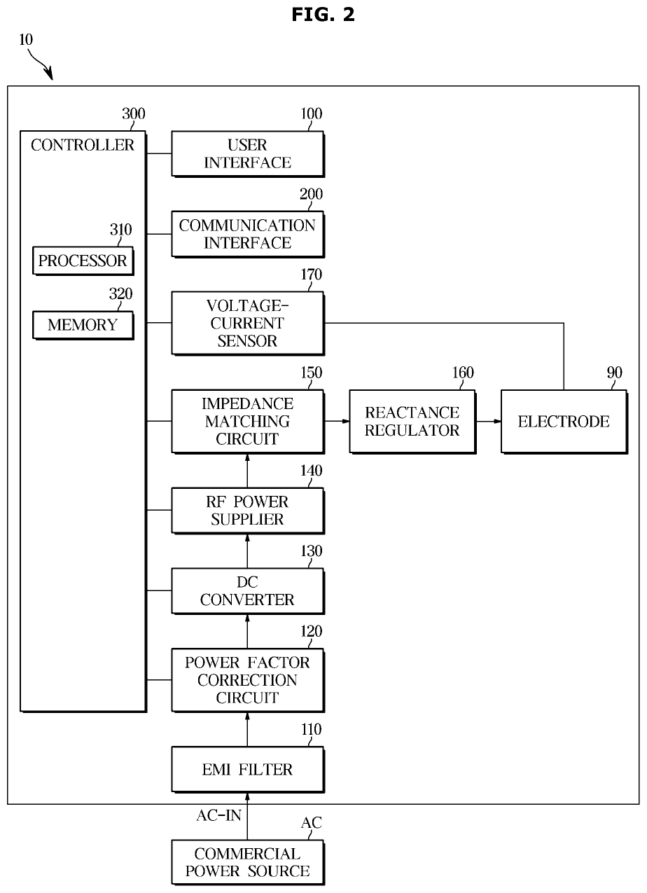

FIG. 2 is a control block diagram of a home appliance according to an embodiment of the disclosure.

Referring to FIG. 2, the home appliance 10 may include a circuit system for performing a heating operation. For example, the home appliance 10 may include an electro magnetic interference (EMI) filter 110, a power factor correction circuit 120, a direct current (DC) converter 130, a radio frequency (RF) power supplier 140, an impedance matching circuit 150, a reactance regulator 160, and an electrode 90. The home appliance 10 may include a voltage-current sensor 170 for detecting an output voltage and an output current of the electrode 90.

The home appliance 10 may include a user interface 100 and a communication interface 200. In addition, the home appliance 10 may include a controller 300 electrically connected to various electronic components and controlling the various electronic components.

The user interface 100 may perform interaction between a user and the home appliance 10. The user interface 100 may obtain user input, and may display various information about the operation of the home appliance 10. The user interface 100 may display operation information of the home appliance 10. For example, the user interface 100 may display an operation mode, an operation temperature, an estimated completion time, and/or a remaining time until the completion of operation. Various operation modes may be provided, and each operation mode may include a predetermined operation setting (e.g., heating temperature, heating time, etc.) depending on the type and/or material of an object.

The user interface 100 may be disposed at various positions of the home appliance 10. The user interface 100 may include an input interface for obtaining user input. The user interface 100 may include an output interface for outputting information.

The input interface may convert sensory information received from the user into an electrical signal. The input interface may include various buttons, switches, and/or dials. For example, the input interface may include a tact switch, a push switch, a slide switch, a toggle switch, a micro switch, a touch switch, a touch pad, a touch screen, a jog dial, and/or a microphone.

The output interface may visually and/or audibly transmit information related to the operation of the home appliance 10 to the user. Information about the operation of the home appliance 10 may be output as an image, text, an indicator, and/or a voice.

In addition, the output interface may display a graphic user interface (GUI) that enables control of the home appliance 10. That is, the output interface may display a user interface element (UI element) such as an icon. The output interface may include at least one of a display or a speaker. The display may also be used as an input device by including a touch screen.

The display may be provided as various types of display panels. For example, the display may include a liquid crystal display (LCD) panel, a light emitting diode (LED) panel, an organic light emitting diode (OLED) panel, or a micro LED panel. The display may also be used as an input device by including a touch screen.

The communication interface 200 may communicate with at least one of a user device 2 or a server 3 via a network. The controller 300 may obtain various information, signals, and/or data from the user device 2 or the server 3 through the communication interface 200. For example, the communication interface 200 may receive a remote control signal from the user device 2. The controller 300 may obtain firmware and/or software for the operation of the home appliance 10 from the server 3 through the communication interface 200.

The communication interface 200 may include various communication circuits. The communication interface 200 may include a wireless communication circuit and/or a wired communication circuit. For example, a communication circuit that supports wireless communication methods such as a wireless local area network, home radio frequency (Home RF), infrared communication, ultra-wide band (UWB) communication, Wi-Fi, Bluetooth, and Zigbee may be provided.

The controller 300 may be electrically connected to components of the home appliance 10, and may control the components of the home appliance 10. For example, the controller 300 may control the RF power supplier 140, the impedance matching circuit 150, and the reactance regulator 160 to supply power to the electrode 90.

The controller 300 may include a processor 310 and memory 320. The memory 320 may include volatile memory (e.g., static random access memory (S-RAM) or dynamic RAM (D-RAM)) and non-volatile memory (e.g., read-only memory (ROM) or erasable programmable ROM (EPROM)). The processor 310 and the memory 320 may be implemented as separate chips or as a single chip. In addition, a plurality of processors and a plurality of memories may be provided.

The processor 310 may process various data and signals using instructions, data, programs, and/or software stored in the memory 320. The processor 310 may generate control signals for controlling the components of the home appliance 10. The processor 310 may include a single core or a plurality of cores.

The processor 310 may be configured to perform various operations of the home appliance 10. The processor 310 may perform the operations of the home appliance 10 according to various embodiments by executing at least one instruction, algorithm, program, and/or software stored in the memory 320. The processor 310 may control one or any combination of the components of the home appliance 10.

The processor 310 may include various types of circuits. For example, the processor 310 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator.

The home appliance 10 may include a chamber for accommodating an object. For example, in a case where the home appliance 10 is a dryer including a drum, a space inside the drum may correspond to the chamber. In a case where the home appliance 10 is a cooking appliance, a defrosting appliance, or a refrigerator, an accommodation space formed inside the cooking appliance, the defrosting appliance, or the refrigerator may correspond to the chamber.

The home appliance 10 may include the electrode 90. A plurality of electrodes 90 may be provided. For example, the home appliance 10 may include two electrodes 90 spaced apart from each other. The home appliance 10 may include a first electrode 90a and a second electrode 90b as will be described below. An object (e.g., food or clothes) may be placed between the two electrodes 90. An accommodation space for placing the object may be formed between the two electrodes 90. The two electrodes 90 may be electrically connected to the RF power supplier 140. When an RF signal is applied to the two electrodes 90, an electric field may be generated between the two electrodes 90. The electric field may vibrate a dielectric (e.g., water molecules) contained in the object (e.g., food or clothes). When the dielectric (e.g., water molecules) vibrates, dipole frictional heat is generated, and thus the dielectric may be heated.

The EMI filter 110 may remove noise contained in alternating current (AC) power supplied from a commercial power source (AC). The EMI filter 110 may be provided as a circuit in which various electronic components such as capacitors, inductors, and diodes are electrically connected in parallel and/or in series. The EMI filter 110 may discharge the noise contained in the AC power through a ground wire. The EMI filter 110 may be provided as a passive filter or an active filter.

In addition, the EMI filter 110 may include a rectifier circuit. The EMI filter 110 may rectify the AC power supplied from the commercial power source (AC). For example, the rectifier circuit may convert a negative voltage of an alternating current (AC) voltage into a positive voltage. The rectifier circuit may include a full-wave rectifier circuit or a half-wave rectifier circuit. The AC voltage rectified by the rectifier circuit may be input to the power factor correction circuit 120.

The power factor correction circuit 120 may compensate a power factor of the AC power. The power factor correction circuit 120 may compensate the power factor by reducing or removing reactive power from among active power and reactive power constituting the AC power. The compensating of the power factor may reduce power loss. The power factor correction circuit 120 may be provided as a circuit in which various electronic components such as capacitors, inductors, and diodes are electrically connected in parallel and/or in series. The power factor correction circuit 120 may be controlled by the controller 300.

The DC converter 130 may convert power output from the power factor correction circuit 120 into DC power suitable for the RF power supplier 140. The DC converter 130 may deliver the converted DC power to the RF power supplier 140. The DC converter 130 may apply a voltage to the RF power supplier 140. The DC converter 130 may be provided as a circuit in which various electronic components such as transistors, inductors, and diodes are electrically connected in parallel and/or in series.

The RF power supplier 140 may generate an RF signal, and apply the RF signal to the electrode 90. Sinusoidal power may be applied to the electrode 90 by the RF signal. The controller 300 may control the RF power supplier 140 to generate an electric field between the plurality of electrodes 90. By supplying RF power to each of the plurality of electrodes 90, an electric field for dielectric heating of the object placed between the plurality of electrodes 90 may be generated.

A phase of the RF power applied to each of the plurality of electrodes 90 may be different. As RF power having different phases is applied to the plurality of electrodes 90, an electric field may be generated between the plurality of electrodes 90. The polarity of each of the plurality of electrodes 90 may be determined according to a phase of an RF signal applied to each of the plurality of electrodes 90. For example, the polarity of the first electrode 90a may be positive (+) and the polarity of the second electrode 90b may be negative (−). In this case, the second electrode 90b may correspond to a ground electrode, and an electric field may be generated between the first electrode 90a and the second electrode 90b. A magnitude of the electric field generated between the plurality of electrodes 90 may vary depending on an intensity of the RF signal applied to the plurality of electrodes 90.

The controller 300 may control the RF power supplier 140 to adjust the RF power applied to the plurality of electrodes 90. The controller 300 may generate a switching signal for turning the RF power supplier 140 on or off. The controller 300 may adjust a frequency of a switching signal for controlling the operation of the RF power supplier 140. The frequency of the switching signal may also be referred to as a ‘switching frequency’. As the frequency of the switching signal increases, a period of the switching signal becomes shorter. As the frequency of the switching signal increases, a switching rate of a switching element SW_pa1 included in the RF power supplier 140 may increase. As the switching rate of the switching element SW_pa1 increases, more RF power may be supplied from the RF power supplier 140 to the plurality of electrodes 90.

The impedance matching circuit 150 may be provided between the RF power supplier 140 and the electrode 90. An RF signal generated by the RF power supplier 140 may be transmitted to the electrode 90 through the impedance matching circuit 150. The impedance matching circuit 150 may match an output impedance of the RF power supplier 140 and the load impedance between the plurality of electrodes 90. In a case where there is a difference between the output impedance of the RF power supplier 140 and the load impedance, reflected power may be generated from the load side, and power transmission efficiency may be reduced. To minimize the reflected power, the output impedance of the RF power supplier 140 and the load impedance requires to be matched. The controller 300 may control the impedance matching circuit 150 to perform impedance matching.

The load impedance may vary depending on various factors, such as the amount, type, and size of the object placed between the plurality of electrodes 90, the amount of water contained in the object, and a distribution state of the object. In addition, the load impedance may vary depending on a size of an empty space between the plurality of electrodes 90.

For example, in a case where dielectrics having a high dielectric constant (e.g., an object with high moisture content) are present between the first electrode 90a and the second electrode 90b to be described below, charges may be accumulated on the dielectrics, and thus the intensity of the electric field formed between the first electrode 90a and the second electrode 90b may be reduced. When the intensity of the electric field decreases, a magnitude of an output voltage, detected at each of the first electrode 90a and the second electrode 90b, may decrease, and the load impedance may decrease. As heating of the object progresses, water contained in the object is removed, and thus the load impedance may be gradually detected to be larger.

As the object is heated, a change rate of the load impedance may decrease. The controller 300 may determine a dryness (degree of dryness) of the object based on the change rate of the load impedance. The controller 300 may determine that drying is complete based on the dryness of the object falling within an allowable error range of a defined reference dryness. In addition, the controller 300 may determine that drying is complete based on the magnitude of the load impedance being greater than or equal to a defined threshold value.

Meanwhile, a distance (gap) between the two electrodes 90 may be larger than a size (e.g., volume, thickness, etc.) of the object, and an empty space may exist between the two electrodes 90. When the object and the empty space between the two electrodes 90 are represented as an equivalent circuit, the object may be represented by a resistor and a capacitor, and the empty space may be represented by a capacitor. In terms of impedance, the empty space may represent a significantly large capacitive reactance. As the empty space is larger, the capacitive reactance of the empty space increases. In other words, the magnitude of the load impedance becomes large due to the empty space, and most of the power transmitted to the load may become reactive power. In this case, despite impedance matching between the output impedance of the RF power supplier 140 and the load impedance between the plurality of electrodes 90 being performed, active power may not be sufficiently transmitted to the object. In a case where active power is not sufficiently transmitted to the object, heating efficiency of the object may decrease.

To address the above, the home appliance 10 according to the disclosure may include a reactance regulator 160 for reducing and/or removing a reactance component of the load impedance. By reducing and/or removing the reactance component of the load impedance, the maximum active power may be transmitted to the object.

The reactance regulator 160 may be disposed between the electrode 90 and the impedance matching circuit 150. For example, the reactance regulator 160 may be disposed between the first electrode 90a and the impedance matching circuit 150. The reactance regulator 160 may also be disposed between the second electrode 90b and the impedance matching circuit 150. The controller 300 may reduce and/or remove the reactance component of the load impedance by controlling the reactance regulator 160.

The voltage-current sensor 170 may detect an output voltage and an output current of the plurality of electrodes 90. For example, the voltage-current sensor 170 may detect an output voltage between the first electrode 90a and the second electrode 90b and an output current of the first electrode 90a. The voltage-current sensor 170 may transmit an electrical signal corresponding to the detected output voltage and output current of the electrode 90 to the controller 300.

The controller 300 may control the voltage-current sensor 170 to periodically detect the output voltage between the first electrode 90a and the second electrode 90b and the output current of the first electrode 90a. The voltage-current sensor 170 may detect the output voltage between the first electrode 90a and the second electrode 90b and the output current of the first electrode 90a at preset time intervals.

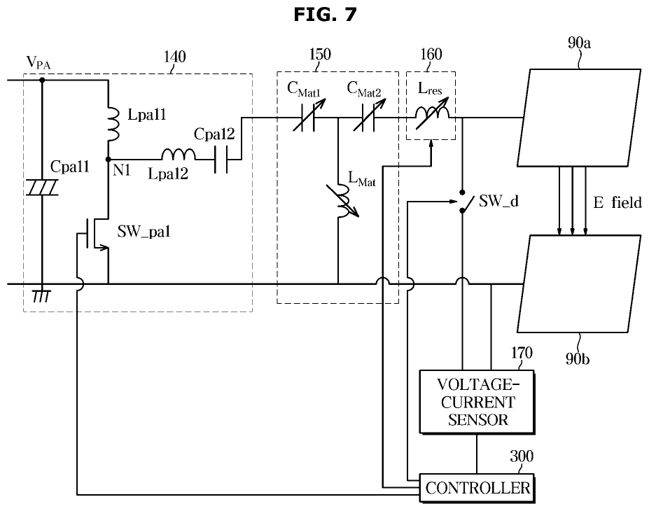

The home appliance 10 may further include a sensor switch for turning the voltage-current sensor 170 on or off. The controller 300 may control the sensor switch to allow the voltage-current sensor 170 to detect the output voltage and the output current at preset time intervals. The sensor switch may be provided to prevent damage to the voltage-current sensor 170. The sensor switch is described in detail in FIG. 7.

The controller 300 may determine the load impedance based on the output voltage and the output current of the electrode 90 obtained from the voltage-current sensor 170. The controller 300 may identify the load impedance between the first electrode 90a and the second electrode 90b based on the output voltage and the output current detected by the voltage-current sensor 170.

The controller 300 may identify a change rate of the load impedance based on the periodically detected output voltage and output current of the electrode 90. The change rate of the load impedance may represent a change amount of the load impedance during a unit time. The unit time may be variously set according to design. The controller 300 may determine a dryness of the object based on the change rate of the load impedance.

As described above, the load impedance may include the impedance of the object and the reactance of the empty space. To maximize active power transmitted to the object, the reactance component of the load impedance requires to be reduced and/or removed. The controller 300 may determine a compensation reactance for removing a first reactance included in the load impedance. The controller 300 may control the reactance regulator 160 to have a second reactance corresponding to the compensation reactance. For example, the controller 300 may control the reactance regulator 160 so that the second reactance of the reactance regulator 160 corresponds to the compensation reactance.

The controller 300 may adjust the compensation reactance to maintain the first reactance of the load impedance within a preset error range while the object is being heated. Although it is ideal to completely remove the first reactance of the load impedance, the first reactance of the load impedance may not be completely removed, because the load impedance changes during heating. The home appliance 10 may control the reactance regulator 160 to maintain the first reactance of the load impedance within the error range.

In addition, the controller 300 may identify a current reactance of the reactance regulator 160. The controller 300 may obtain a difference value between the current reactance of the reactance regulator 160 and the determined compensation reactance. The controller 300 may determine the second reactance of the reactance regulator 160 by adding the obtained difference value to the current reactance or by subtracting the obtained difference value from the current reactance. Calculation of the difference value between the current reactance of the reactance regulator 160 and the compensation reactance may not be required to control the reactance regulator 160. However, using the difference value between the current reactance and the compensation reactance may improve processing and control speed.

The controller 300 may obtain information about the object placed between the first electrode 90a and the second electrode 90b through the user interface 100 or the communication interface 200. The controller 300 may identify the load impedance corresponding to the information about the object from a lookup table stored in the memory 320. For example, the information about the object may include at least one of the type, size, weight, or number of the object. The lookup table may include load impedance information corresponding to object information. When the object is heated, a state of the object may change. The lookup table may include the load impedance information corresponding to a state change of the object.

Meanwhile, the home appliance 10 may not include the voltage-current sensor 170 described above. In a case where the home appliance 10 does not include the voltage-current sensor 170, the home appliance 10 may determine the load impedance between the first electrode 90a and the second electrode 90b based on user input including object information through the user interface 100 or the communication interface 200.

In addition, in a case where the home appliance 10 includes the voltage-current sensor 170, the home appliance 10 may determine the load impedance between the first electrode 90a and the second electrode 90b in consideration of object information input by a user. For example, when a user input is obtained through the user interface 100 or the communication interface 200, the controller 300 of the home appliance 10 may determine the load impedance based on the object information included in the user input. Thereafter, the controller 300 may identify a change in the load impedance due to the heating of the object, based on the output voltage and the output current detected by the voltage-current sensor 170. In a case where a user input is not received, the controller 300 may determine the load impedance based on the output voltage and the output current detected by the voltage-current sensor 170.

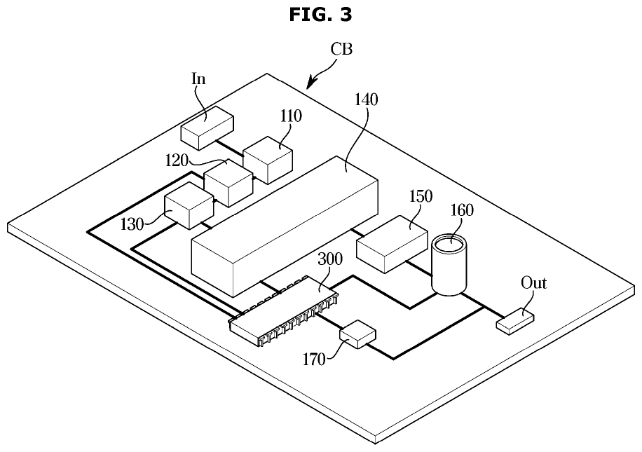

FIG. 3 illustrates an example of a circuit board including a circuit system for a heating operation of a home appliance according to an embodiment of the disclosure.

Referring to FIG. 3, the EMI filter 110, the power factor correction circuit 120, the DC converter 130, the RF power supplier 140, the impedance matching circuit 150, the reactance regulator 160, the voltage-current sensor 170, and the controller 300 may be disposed on a circuit board CB and may be electrically connected to each other. The circuit board CB may correspond to a printed circuit board.

AC power supplied from a commercial power source (AC) may be input to the EMI filter 110 through an input pin (In). The reactance regulator 160 and the voltage-current sensor 170 may be electrically connected to the electrode 90 through an output pin (Out).

Although it has been described that the EMI filter 110, the power factor correction circuit 120, the DC converter 130, the RF power supplier 140, the impedance matching circuit 150, the reactance regulator 160, the voltage-current sensor 170, and the controller 300 are provided on a single circuit board, the disclosure is not limited thereto. The EMI filter 110, the power factor correction circuit 120, the DC converter 130, the RF power supplier 140, the impedance matching circuit 150, the reactance regulator 160, the voltage-current sensor 170, and the controller 300 may be separately disposed on a plurality of circuit boards. The plurality of circuit boards may be electrically connected to each other.

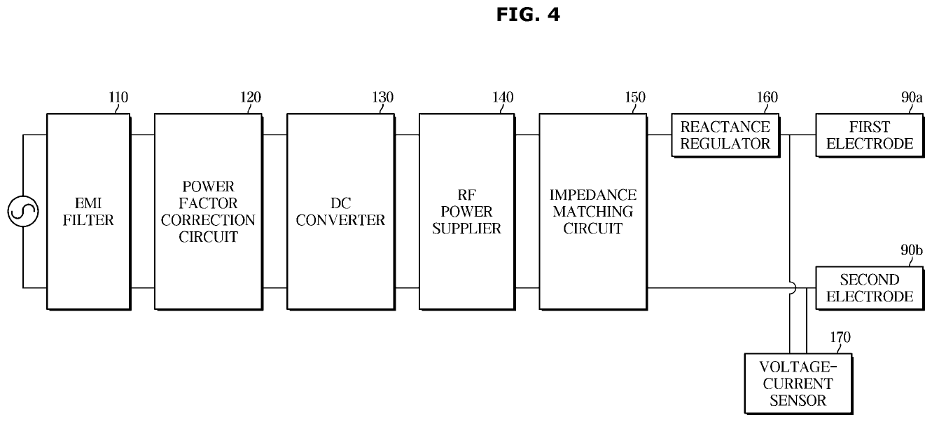

FIG. 4 is a block diagram of a circuit system for a heating operation of a home appliance according to an embodiment of the disclosure.

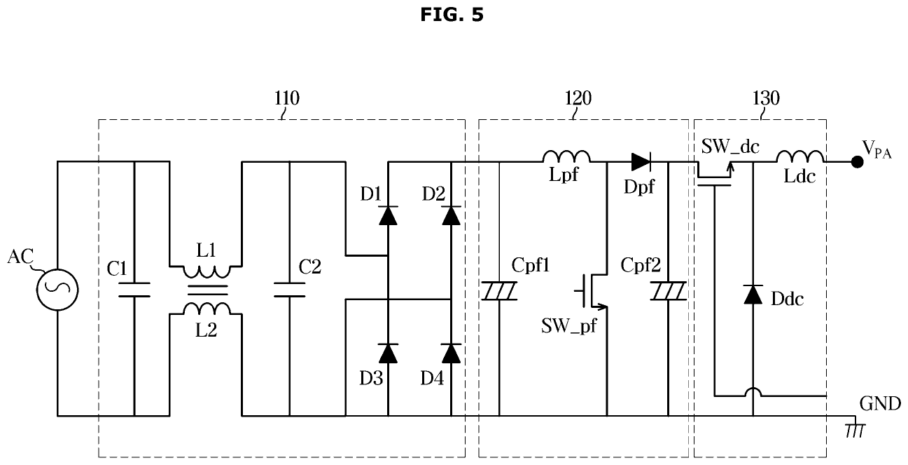

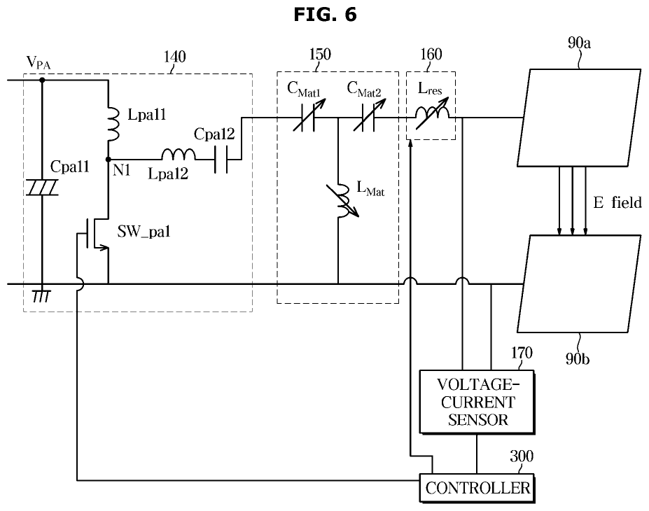

FIGS. 5 and 6 illustrate a detailed structure of the circuit system illustrated in FIG. 4 according to various embodiments of the disclosure.

Referring to FIGS. 4, 5, and 6, the home appliance 10 may include a plurality of electrodes 90. For example, the home appliance 10 may include the first electrode 90a and the second electrode 90b.

The first electrode 90a and the second electrode 90b may be disposed to face each other. The first electrode 90a and the second electrode 90b may be spaced apart from each other. The first electrode 90a may be disposed on a first side of the chamber. The second electrode 90b may be disposed on a second side of the chamber facing the first side of the chamber. Two or more first electrodes 90a and two or more second electrodes 90b may be provided.

Each of the first electrode 90a and the second electrode 90b may have various shapes. For example, the first electrode 90a and the second electrode 90b may have a flat plate shape or a curved plate shape. The first electrode 90a and the second electrode 90b may have a flat plate shape including a plurality of openings. The first electrode 90a and the second electrode 90b may include a plurality of conductors spaced apart from each other.

The number and position of the electrodes 90 may vary depending on the design. For example, three or more electrodes may be disposed parallel to each other and spaced apart from each other in the chamber. In addition, the length, area, and/or thickness of the electrode 90 may also vary depending on the design.

An accommodation space for placing an object may be formed between the first electrode 90a and the second electrode 90b. The first electrode 90a and the second electrode 90b may be electrically connected to the RF power supplier 140. When an RF signal is applied to the first electrode 90a and the second electrode 90b, an electric field may be generated between the first electrode 90a and the second electrode 90b. The electric field may vibrate a dielectric (e.g., water molecules) contained in the object (e.g., food or clothes). When the dielectric (e.g., water molecules) vibrates, dipole frictional heat is generated, and thus the dielectric may be heated.

The EMI filter 110 may be connected to the commercial power source (AC), and may remove noise contained in the AC power supplied from the commercial power source. In addition, the EMI filter 110 may include a rectifier circuit for rectifying AC power supplied from the commercial power source. For example, the rectifier circuit may convert a negative voltage of an AC voltage into a positive voltage. The EMI filter 110 may include a full-wave rectifier circuit or a half-wave rectifier circuit.

The EMI filter 110 may be provided as a circuit in which various components are electrically connected in parallel and/or in series. For example, the EMI filter 110 may include a plurality of capacitors C1 and C2 connected in parallel, a plurality of inductors L1 and L2 implementing a transformer, and a plurality of diodes D1, D2, D3, and D4 forming a bridge. The plurality of diodes D1, D2, D3, and D4 may correspond to the rectifier circuit. The circuit structure of the EMI filter 110 is not limited to that illustrated. The circuit structure of the EMI filter 110 may vary depending on the design. The EMI filter 110 may provide rectified AC power to the power factor correction circuit 120.

The power factor correction circuit 120 may compensate a power factor of the AC power provided from the EMI filter 110. The power factor correction circuit 120 may provide power with the corrected power factor to the DC converter 130. The power factor correction circuit 120 may be provided as a circuit in which various components are electrically connected in parallel and/or in series. For example, the power factor correction circuit 120 may include a plurality of electrolytic capacitors Cpf1 and Cpf2, an inductor Lpf, a diode Dpf, and a switching element SW_pf. The switching element SW_pf may correspond to a transistor. The transistor may allow or block the flow of current depending on whether a voltage is applied. The circuit structure of the power factor correction circuit 120 is not limited to that illustrated. The circuit structure of the power factor correction circuit 120 may vary depending on the design.

The DC converter 130 may convert the power output from the power factor correction circuit 120 into DC power. The DC converter 130 may deliver the converted DC power to the RF power supplier 140. The DC converter 130 may be provided as a circuit in which various components are electrically connected in parallel and/or in series. For example, the DC converter 130 may include a switching element SW_dc, an inductor Ldc, and a diode Ddc. The switching element SW_dc may correspond to a transistor. The switching element SW_dc and the inductor Ldc may be connected in series. The diode Ddc may be connected to a connection node of the switching element SW_dc and the inductor Ldc. The circuit structure of the DC converter 130 is not limited to that illustrated. The circuit structure of the DC converter 130 may vary depending on the design.

The RF power supplier 140 may be provided as a circuit including various components for generating an RF signal. For example, the RF power supplier 140 may include an electrolytic capacitor Cpa11, a capacitor Cpa12, a plurality of inductors Lpa11 and Lpa12, and a switching element SW_pa1. The electrolytic capacitor Cpa11 may connect a V_{PA} node and the ground (GND).

The switching element SW_pa1 and the inductor Lpa11 may be connected in series between the V_{PA} node and the ground (GND). The inductor Lpa11 may be connected to the V_{PA} node and an N1 node. A drain of the switching element SW_pa1 may be connected to the N1 node, and a source of the switching element SW_pa1 may be connected to the ground (GND). The inductor Lpa12 and the capacitor Cpa12 connected in series may be disposed between the N1 node connecting the switching element SW_pa1 and the inductor Lpa11 and the impedance matching circuit 150.

The switching element SW_pa1 of the RF power supplier 140 may correspond to a transistor. The RF power supplier 140 may be activated (ON) or deactivated (OFF) according to the operation of the switching element SW_pa1. The operation of the RF power supplier 140 may be controlled based on a switching signal VG applied to the switching element SW_pa1. In response to the switching element SW_pa1 being turned on (ON), the operation of the RF power supplier 140 may be activated. In response to the switching element SW_pa1 being turned off (OFF), the operation of the RF power supplier 140 may be deactivated.

The impedance matching circuit 150 may include a variable inductor L_{Mat} and a plurality of variable capacitors C_{Mat1} and C_{Mat2}. The first variable capacitor C_{Mat1} and the second variable capacitor C_{Mat2} may be connected in series. The variable inductor L_{Mat} may be connected to a node where the first variable capacitor C_{Mat1} and the second variable capacitor C_{Mat2} are connected. The variable inductor L_{Mat} and the plurality of variable capacitors C_{Mat1} and C_{Mat2} may form a T-type circuit structure. The controller 300 may control the variable inductor L_{Mat} and each of the plurality of variable capacitors C_{Mat1} and C_{Mat2} to perform impedance matching between an output impedance of the RF power supplier 140 and the load impedance between the two electrodes 90a and 90b.

The circuit structure of the impedance matching circuit 150 is not limited to that illustrated. For example, the impedance matching circuit 150 may be provided as a circuit in which a plurality of inductors, a plurality of capacitors, and a plurality of switches are electrically connected in series and/or in parallel. The plurality of switches included in the impedance matching circuit 150 may be opened or closed under the control of the controller 300. Impedance matching may be performed by controlling the plurality of switches. The structure of the impedance matching circuit 150 may vary depending on the design.

The controller 300 may perform impedance matching in response to a change in the load impedance by controlling the impedance matching circuit 150.

The reactance regulator 160 may be disposed between the electrode 90 and the impedance matching circuit 150. For example, the reactance regulator 160 may be disposed between the first electrode 90a and the impedance matching circuit 150. The reactance regulator 160 may also be disposed between the second electrode 90b and the impedance matching circuit 150. The reactance regulator 160 may include a variable inductor Lᵣₑₛ. The controller 300 may control the reactance regulator 160 to reduce and/or remove a reactance component of the load impedance. The controller 300 may adjust an inductance of the variable inductor Lᵣₑₛ.

For example, the load impedance may include a resistor and a capacitive reactance. The reactance regulator 160 may provide an inductive reactance. The capacitive reactance of the load impedance and the inductive reactance of the reactance regulator 160 may offset each other. In other words, the load impedance and the reactance regulator 160 may form a resonance circuit. The reactance provided by the reactance regulator 160 may be referred to as a compensation reactance.

As described above, the load impedance includes a capacitive reactance corresponding to an empty space between the two electrodes 90. Because the impedance matching circuit 150 only performs matching between the output impedance of the RF power supplier 140 and the load impedance, the reactance included in the load impedance may not be reduced and/or removed. The home appliance 10 may use the reactance regulator 160 to reduce and/or remove the reactance of the load impedance, thereby transmitting the maximum active power to the object.

The voltage-current sensor 170 may detect an output voltage between the first electrode 90a and the second electrode 90b and an output current of the first electrode 90a. The voltage-current sensor 170 may transmit an electrical signal corresponding to the detected output voltage and output current of the electrode 90 to the controller 300.

FIG. 7 illustrates a modified example of the circuit system illustrated in FIG. 6 according to an embodiment of the disclosure.

Referring to FIG. 7, the home appliance 10 may further include a sensor switch SW_d for turning the voltage-current sensor 170 on or off. The controller 300 may control the sensor switch SW_d to allow the voltage-current sensor 170 to detect an output voltage and an output current at preset time intervals.

The sensor switch SW_d may be provided to prevent damage to the voltage-current sensor 170. For example, in a case where relatively large RF power is required to be supplied to the electrode 90, applying a large voltage and a large current to the voltage-current sensor 170 at short time intervals may cause damage to the voltage-current sensor 170. The controller 300 of the home appliance 10 may increase a detection interval at which the voltage-current sensor 170 detects the output voltage and the output current in order to prevent damage to the voltage-current sensor 170.

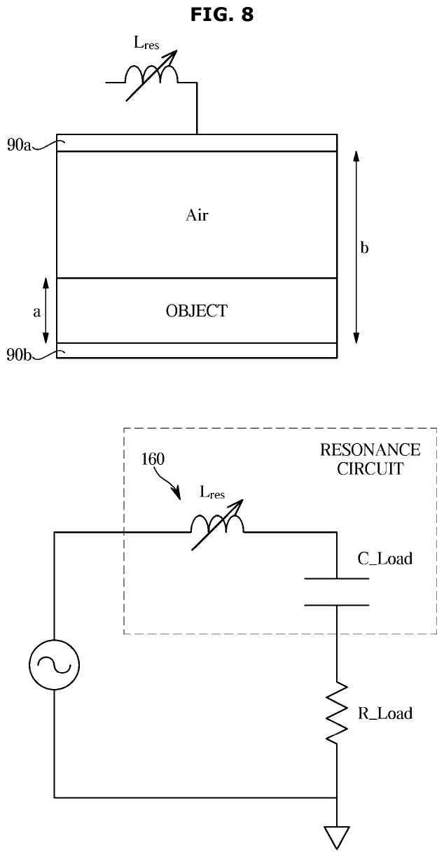

FIG. 8 is a diagram illustrating load impedance corresponding to an object and an empty space between two electrodes according to an embodiment of the disclosure.

Referring to FIG. 8, a distance b between the first electrode 90a and the second electrode 90b may be larger than a size (e.g., volume, thickness a, etc.) of an object, and an empty space (Air) may exist between the first electrode 90a and the second electrode 90b. The load between the first electrode 90a and the second electrode 90b includes the object and the empty space. When the object and the empty space are represented as an equivalent circuit, the object may be represented by a resistor and a capacitor, and the empty space may be represented by a capacitor. Accordingly, the load may be represented as a resistance R_Load and a capacitance C_Load. The resistance R_Load and the capacitance C_Load of the load may be connected in series or in parallel.

In terms of impedance, the empty space may represent a significantly large capacitive reactance. As the empty space is larger, the capacitive reactance of the empty space increases. In other words, the magnitude of the load impedance becomes large due to the empty space, and most of the power transmitted to the load may become reactive power. In a case where active power is not sufficiently transmitted to the load, heating efficiency of the object may decrease. In addition, in a case where the capacitive reactance corresponding to the empty space dominates most of the load impedance, an actual impedance of the object may not be accurately measured.

The home appliance 10 according to the disclosure may reduce and/or remove the reactance of the load impedance using the reactance regulator 160 disposed at a front side of the load. The reactance regulator 160 may include a variable inductor Lᵣₑₛ. The controller 300 of the home appliance 10 may control the reactance regulator 160 to have a compensation reactance corresponding to the reactance of the load impedance.

For example, the reactance regulator 160 may provide an inductive reactance. The capacitive reactance of the load impedance and the inductive reactance of the reactance regulator 160 may offset each other. In other words, the load impedance and the reactance regulator 160 may form a resonance circuit. By reducing and/or removing the reactance component of the load impedance, the maximum active power may be transmitted to the object. In addition, the actual impedance of the object may also be relatively accurately measured.

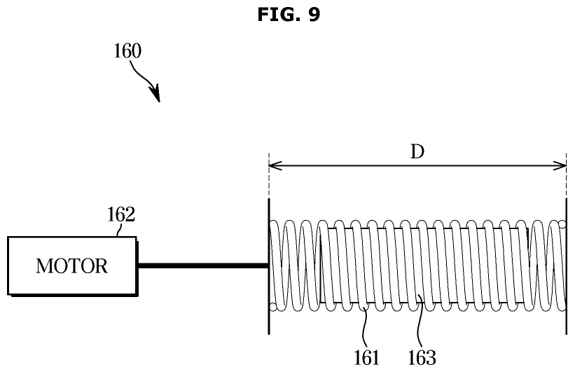

FIGS. 9, 10, and 11 illustrate reactance regulators according to various embodiments of the disclosure.

Referring to FIG. 9, the reactance regulator 160 may include a core 163, a coil 161 provided to wind around the core 163, and a motor 162 connected to one side of the coil 161. The controller 300 of the home appliance 10 may control the motor 162 to adjust a length of the coil 161 so that a second reactance of the reactance regulator 160 corresponds to a compensation reactance.

For example, the controller 300 of the home appliance 10 may identify a current reactance of the reactance regulator 160. The controller 300 may determine the compensation reactance corresponding to a reactance of a load impedance. The controller 300 may obtain a difference value between the current reactance of the reactance regulator 160 and the determined compensation reactance.

The controller 300 may determine a rotation angle and a rotation direction of the motor 162 based on the difference value between the current reactance of the reactance regulator 160 and the determined compensation reactance. For example, when the motor 162 rotates in a clockwise direction, a length D of the coil 161 may decrease. When the motor 162 rotates in a counterclockwise direction, the length D of the coil 161 may increase.

The reactance of the reactance regulator 160 may correspond to an inductance. In a case where the current reactance of the reactance regulator 160 is greater than the determined compensation reactance, the controller 300 may increase the length D of the coil 161 to reduce the reactance of the reactance regulator 160. Because a spacing between windings increases when the length D of the coil 161 increases, the inductance may decrease. In other words, when the length D of the coil 161 increases, a winding density decreases, and thus the inductance may decrease.

Conversely, in a case where the current reactance of the reactance regulator 160 is less than the determined compensation reactance, the controller 300 may reduce the length D of the coil 161 to increase the reactance of the reactance regulator 160. Because the spacing between windings decreases when the length D of the coil 161 decreases, the inductance may increase. In other words, when the length D of the coil 161 decreases, a winding density increases, and thus the inductance may increase.

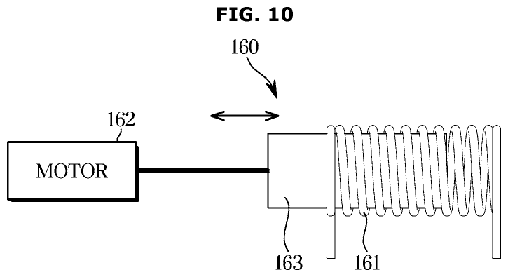

Referring to FIG. 10, the reactance regulator 160 may include the core 163, the coil 161 provided to wind around the core 163, and the motor 162 connected to one side of the core 163. The controller 300 of the home appliance 10 may control the motor 162 to adjust a position of the core 163 so that the second reactance of the reactance regulator 160 corresponds to the compensation reactance. A length of the coil 161 may be equal to or shorter than the length of the core 163.

For example, in a case where a current reactance of the reactance regulator 160 is greater than the determined compensation reactance, the controller 300 may move the position of the core 163 toward the motor 162 side to decrease the reactance of the reactance regulator 160. When the position of the core 163 moves toward the motor 162 side, the coil 161 may be wound around only a portion of the core 163. In other words, the number of turns of the coil 161 winding around the core 163 decreases, and thus the inductance may decrease.

Conversely, in a case where the current reactance of the reactance regulator 160 is less than the determined compensation reactance, the controller 300 may move the position of the core 163 toward an opposite side of the motor 162 to increase the reactance of the reactance regulator 160. When the position of the core 163 moves toward the opposite side of the motor 162, the number of turns of the coil 161 winding around the core 163 may increase. When the number of turns of the coil 161 winding around the core 163 increases, the inductance may increase.

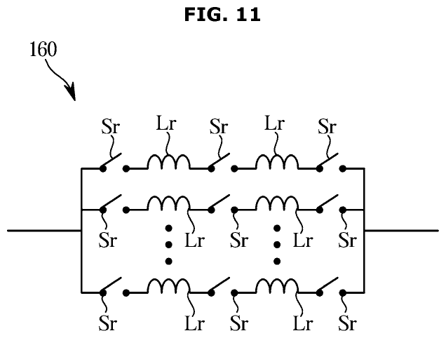

Referring to FIG. 11, the reactance regulator 160 may include a plurality of inductors Lr arranged in series and in parallel and a plurality of switches Sr for connecting the plurality of inductors Lr. The controller 300 of the home appliance 10 may turn each of the plurality of switches Sr on or off so that the second reactance of the reactance regulator 160 corresponds to the compensation reactance. In a case where the plurality of inductors Lr are connected in series, the inductance may increase. In a case where the plurality of inductors Lr are connected in parallel, the inductance may decrease.

The structure of the reactance regulator 160 is not limited to those illustrated in FIGS. 9, 10, and 11. The reactance regulator 160 may have various structures according to design.

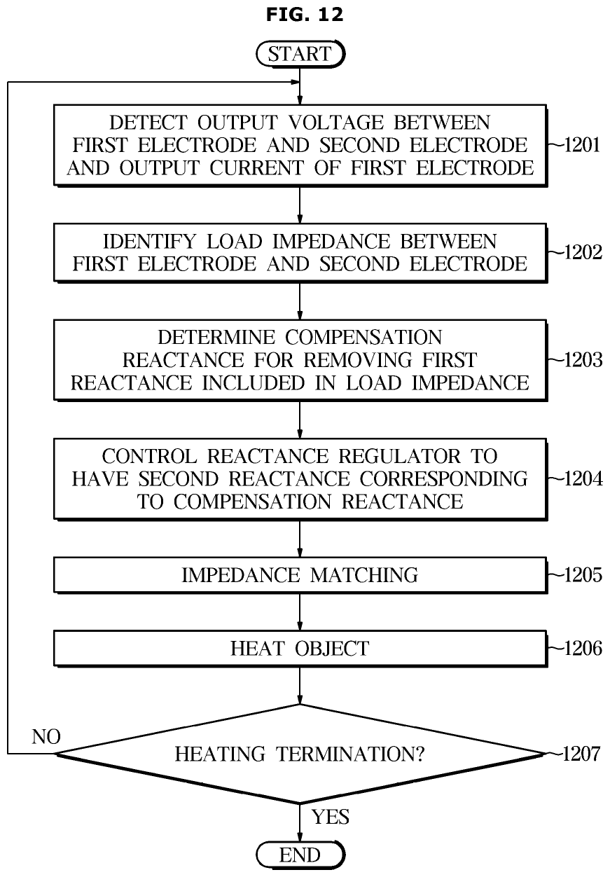

FIG. 12 is a flowchart illustrating a method for controlling a home appliance according to an embodiment of the disclosure.

Referring to FIG. 12, the controller 300 of the home appliance 10 may control the voltage-current sensor 170 to detect an output voltage between the first electrode 90a and the second electrode 90b and an output current of the first electrode 90a at operation 1201. The controller 300 may identify a load impedance between the first electrode 90a and the second electrode 90b based on the output voltage and the output current detected by the voltage-current sensor 170 at operation 1202. The controller 300 may identify a first reactance included in the load impedance.

The controller 300 may determine a compensation reactance for removing the first reactance included in the load impedance at operation 1203. The controller 300 may control the reactance regulator 160 to have a second reactance corresponding to the compensation reactance at operation 1204. The home appliance 10 may offset the first reactance of the load impedance by controlling the reactance regulator 160. By reducing and/or removing the reactance component of the load impedance, the maximum active power may be transmitted to an object.

Thereafter, the controller 300 may control the impedance matching circuit 150 to perform impedance matching between an output impedance of the RF power supplier 140 and the load impedance at operation 1205. In a case where the output impedance of the RF power supplier 140 is different from the load impedance, reflected power is generated from the load side, and power transmission efficiency is reduced. The reflected power may be minimized through impedance matching between the output impedance of the RF power supplier 140 and the load impedance.

After the impedance matching, the controller 300 may operate the RF power supplier 140 to generate an electric field between the first electrode 90a and the second electrode 90b to heat the object at operation 1206. The electric field generated between the first electrode 90a and the second electrode 90b may vibrate a dielectric (e.g., water molecules) contained in the object (e.g., food or clothes). When the dielectric (e.g., water molecules) vibrates, dipole frictional heat is generated, and thus the object may be heated.

The controller 300 may determine whether to terminate heating of the object at operation 1207. For example, based on a dryness (dryness level) of the object falling within an allowable error range of a defined reference dryness, the controller 300 may determine that drying is complete and determine that heating is to be ended. Based on a magnitude of the load impedance being greater than or equal to a defined threshold value, the controller 300 may determine that drying is complete and terminate the heating. In addition, the controller 300 may determine that heating is to be ended based on an elapse of a preset heating time. The controller 300 may stop operating the RF power supplier 140 so that RF power is not supplied to the electrode 90, based on determining that heating is to be ended.

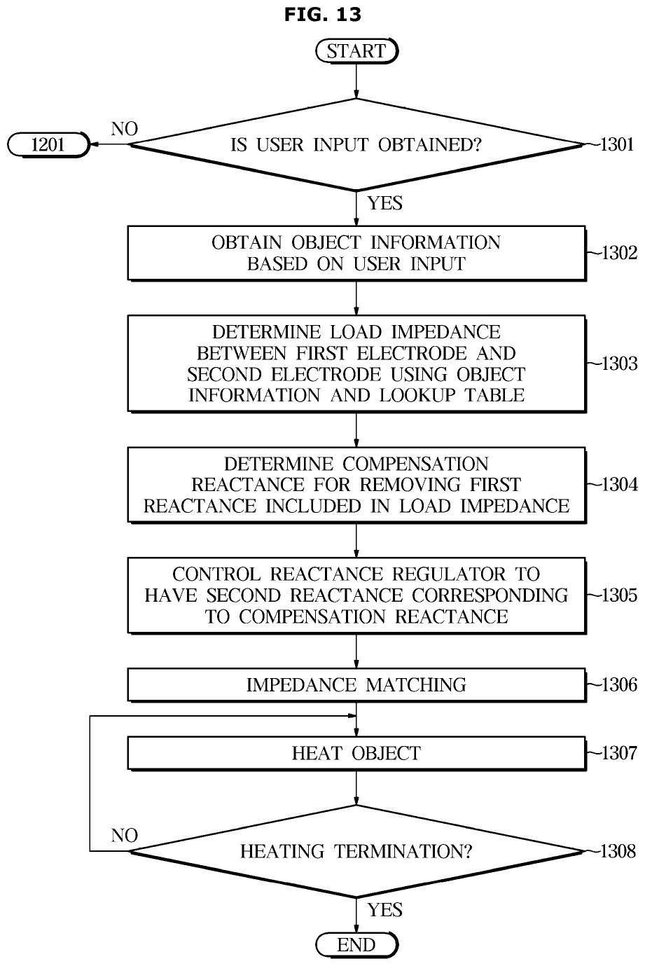

FIG. 13 is a flowchart illustrating a method for controlling a home appliance according to an embodiment of the disclosure.

Referring to FIG. 13, the controller 300 of the home appliance 10 may identify whether a user input is obtained via the user interface 100 or the communication interface 200 at operation 1301.

In a case where a user input is not received, the controller 300 may control the voltage-current sensor 170 to detect an output voltage between the first electrode 90a and the second electrode 90b and an output current of the first electrode 90a at operation 1301.

The user input may include information (object information) about an object placed between the first electrode 90a and the second electrode 90b. When the user input is received via the user interface 100 or the communication interface 200, the controller 300 may obtain the object information included in the user input at operation 1302. For example, the object information may include at least one of the type, size, weight, or number of the object.

The controller 300 may determine a load impedance between the first electrode 90a and the second electrode 90b using the obtained object information and a lookup table stored in the memory 320 at operation 1303. The lookup table may include load impedance information corresponding to object information. In addition, the lookup table may include load impedance information corresponding to a state change of the object.

The controller 300 may identify a first reactance included in the load impedance. The controller 300 may determine a compensation reactance for removing the first reactance included in the load impedance at operation 1304. The controller 300 may control the reactance regulator 160 to have a second reactance corresponding to the compensation reactance at operation 1305.

Thereafter, the controller 300 may control the impedance matching circuit 150 to perform impedance matching between an output impedance of the RF power supplier 140 and the load impedance at operation 1306. After the impedance matching, the controller 300 may operate the RF power supplier 140 to generate an electric field between the first electrode 90a and the second electrode 90b to heat the object at operation 1307.

The controller 300 may determine whether to terminate heating of the object at operation 1308. For example, based on a dryness of the object falling within an allowable error range of a defined reference dryness, the controller 300 may determine that drying is complete and determine that heating is to be ended. Based on a magnitude of the load impedance being greater than or equal to a defined threshold value, the controller 300 may determine that drying is complete and terminate the heating. In addition, the controller 300 may determine that heating is to be ended based on an elapse of a preset heating time. The controller 300 may stop operating the RF power supplier 140 so that RF power is not supplied to the electrode 90, based on determining that heating is to be ended.

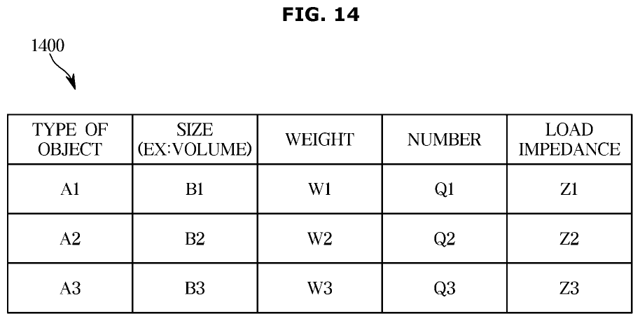

FIG. 14 illustrates a lookup table according to an embodiment of the disclosure.

Referring to FIG. 14, the memory 320 may store a lookup table 1400. The lookup table 1400 may include a load impedance corresponding to information about an object (object information). In addition, the lookup table 1400 may include load impedance information corresponding to a state change of the object. For example, the object information may include at least one of the type, size (e.g., volume), weight, or number of the object. The controller 300 may identify the load impedance corresponding to the object information from the lookup table 1400 stored in the memory 320.

In a case where the object placed between the two electrodes 90 has an A1 type, a B1 size, a W1 weight, and a Q1 number of objects, the load impedance of the object may be determined as Z1. In a case where the object has an A2 type, a B2 size, a W2 weight, and a Q2 number of objects, the load impedance of the object may be determined as Z2. In a case where the object has an A3 type, a B3 size, a W3 weight, and a Q3 number of objects, the load impedance of the object may be determined as Z3.

Depending on design and/or setting, at least two of A1, A2, and A3 may represent the same type of object or different types of objects. At least two of B1, B2, and B3 may represent the same size or different sizes. At least two of W1, W2, and W3 may represent the same weight or different weights. At least two of Q1, Q2, and Q3 may represent the same number of objects or different numbers of objects. At least two of Z1, Z2, and Z3 may represent the same load impedance or different load impedances.

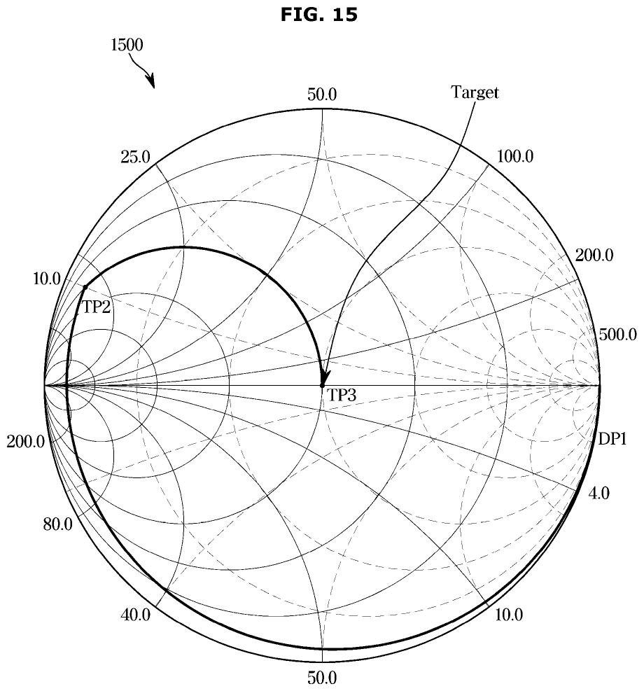

FIG. 15 is a Smith chart illustrating an impedance matching method according to the related art.

Referring to a Smith chart 1500 of FIG. 15, in an existing technology, impedance matching between an output impedance of the RF power supplier 140 and a load impedance is performed in a state where a reactance of the load impedance is not removed. When the impedance matching according to the existing technology is represented on the Smith chart 1500, a target point TP3 corresponding to the output impedance of the RF power supplier 140 is reached after passing through an intermediate point TP2 from a starting point DP1 corresponding to the load impedance. The impedance corresponding to the intermediate point TP2 may include a resistance component and an inductive reactance component. Although power reflected from the load side is reduced through impedance matching, active power may not be sufficiently transmitted to the object because the reactance of the load impedance still has a large value.

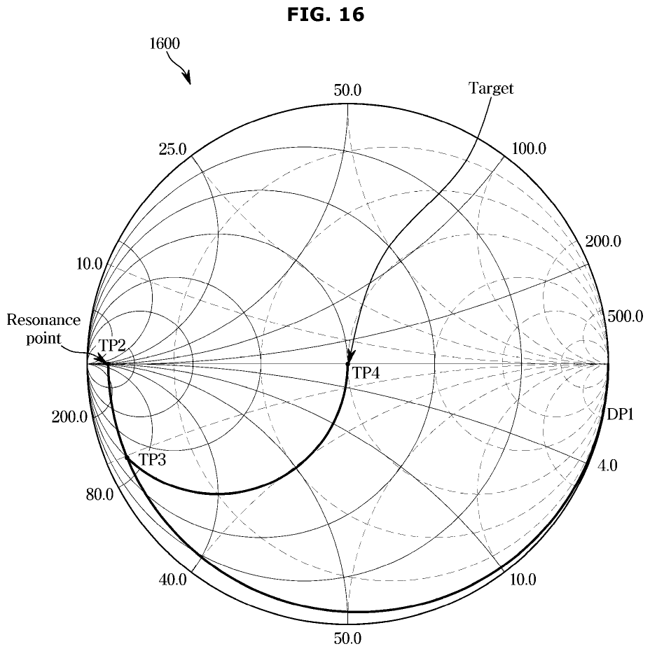

FIG. 16 is a Smith chart illustrating an impedance matching method according to an embodiment of the disclosure.

Referring to FIG. 16, a Smith chart 1600 is illustrated. The home appliance 10 according to the disclosure may perform matching between an output impedance of the RF power supplier 140 and a load impedance after removing a reactance of the load impedance. When the impedance matching is represented on the Smith chart 1600, a resonance point TP2 is reached first from a starting point DP1 corresponding to the load impedance as reactance removal of the load impedance is performed first by the reactance regulator 160. Thereafter, a target point TP4 corresponding to the output impedance of the RF power supplier 140 is reached after passing through an intermediate point TP3 from the resonance point TP2. The impedance corresponding to the intermediate point TP3 may include a resistance component and a capacitive reactance component.

As such, the home appliance 10 according to the disclosure may perform impedance matching after reducing and/or removing the reactance component of the load impedance. Accordingly, the maximum active power may be transmitted to the object. An actual impedance of the object may also be relatively accurately measured. In addition, a voltage and a current applied to the electrode for heating the object may also be reduced. As a result, power consumption may be reduced and the stability of the circuit system may be improved.

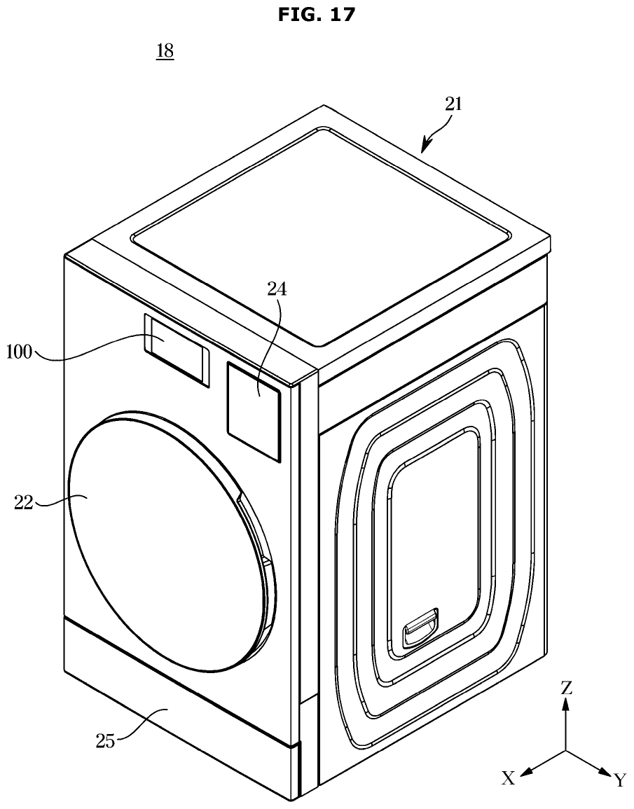

FIG. 17 illustrates an apparatus corresponding to a dryer as a home appliance according to an embodiment of the disclosure.

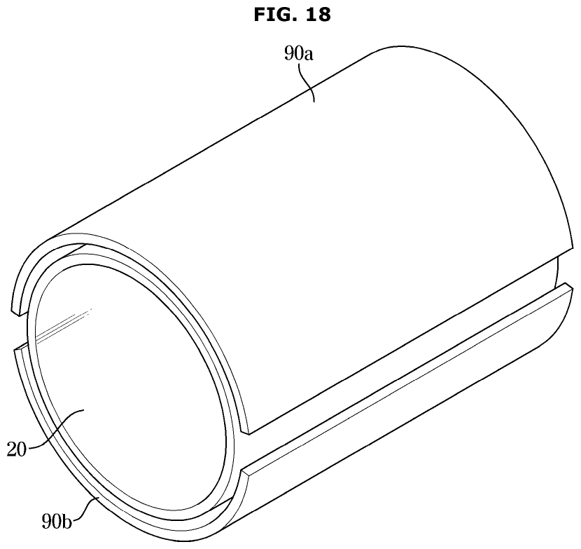

FIG. 18 illustrates an arrangement structure of a drum and electrodes of the dryer illustrated in FIG. 17 according to an embodiment of the disclosure.

Referring to FIGS. 17 and 18, the home appliance 10 may be provided as the dryer 18 described in FIG. 1. The dryer 18 may include a cabinet 21 forming an exterior, and a drum 20 rotatably installed in the cabinet 21. An inner space of the drum 20 may form a chamber for accommodating an object. The cabinet 21 may have a substantially hexahedral shape.

An inlet for putting in or taking out an object (e.g., clothes) to or from the drum 20 is provided on a front side of the cabinet 21. The dryer 18 may include a door 22 to open and close the inlet. A user may put the object into the drum 20 or take out the object through the inlet after opening the door 22. When the inlet is closed by the door 22 and the home appliance 10 starts operating, a door lock may lock the door 22.

A user interface 100 for interaction between the user and the dryer 18 may be disposed on an upper front side of the cabinet 21. The user interface 100 may obtain user input and may display various information about the dryer 18. The position of the user interface 100 is not limited to the front side. The user interface 100 may be provided at various positions of the dryer 18.

The user interface 100 may include a display. In addition, the user interface 100 may include an input interface for obtaining user input about the operation of the dryer 18. The input interface may include a rotatable dial and various buttons. In addition, the user interface 100 may include various types of input interfaces and displays.

The dryer 18 may include a filter 24 for filtering foreign substances such as lint generated during a drying process of the object.

The dryer 18 may be a washer-dryer combo. In a case where the dryer 18 is a washer-dryer combo, the dryer 18 may further include a tub for accommodating water and a detergent supply device 25 for supplying detergent into the tub.

The dryer 18 may include a driving device for rotating the drum 20. For example, the driving device may include a motor, and a pulley and a belt for transmitting power of the motor to the drum 20.

A fan for flowing air may be disposed inside the cabinet 21. Air inside the drum 20 may circulate by rotation of the fan.

A plurality of electrodes 90 may be arranged between the cabinet 21 and the drum 20. For example, a first electrode 90a and a second electrode 90b may be provided between the cabinet 21 and the drum 20. The first electrode 90a and the second electrode 90b may be spaced apart from each other along a circumference of the drum 20. Two or more first electrodes 90a and two or more second electrodes 90b may be provided. The first electrode 90a and the second electrode 90b may be spaced apart from the cabinet 21 and the drum 20.

Although the home appliance 10 is exemplified as a drum dryer, the disclosure is not limited thereto. The home appliance 10 may also be provided in a form having an accommodation space defined by a shelf. The home appliance 10 may not include the drum 20, and in this case, a position of an object placed between the first electrode 90a and the second electrode 90b may not change.

The plurality of electrodes 90 may be arranged along the circumference of the drum 20. The plurality of electrodes 90 may be spaced apart from each other. In the case of the home appliance 10 including the drum 20, each of the plurality of electrodes 90 may be provided in a curved plate shape. In the case of the home appliance 10 without the drum 20, each of the plurality of electrodes 90 may be provided in a flat plate shape.

The plurality of electrodes 90 may include the first electrode 90a and the second electrode 90b. The first electrode 90a and the second electrode 90b may be spaced apart along an outer circumferential surface of the drum 20.

The plurality of electrodes 90 may be fixed between the cabinet 21 and the drum 20. The drum 20 is not connected to the electrode 90. Accordingly, the electrode 90 does not restrict the rotation of the drum 20. In addition, because the plurality of electrodes 90 are disposed along the circumference of the drum 20, an electric field may be generated within the drum 20. Accordingly, the home appliance 10 according to the disclosure may generate an electric field inside the drum 20 through the electrode 90 even while the drum 20 is rotating, and may perform drying of the object.

Although two electrodes 90 are shown, the number of electrodes 90 is not limited thereto. The home appliance 10 may also include two or more electrodes 90.

The home appliance 10 according to the disclosure includes a circuit structure capable of supplying power suitable for drying an object. When power is supplied to the electrodes 90, an electric field may be generated in the chamber. The electric field generated inside the drum 20 by the electrodes 90 may vibrate a dielectric (e.g., water molecules) contained in the object. When the dielectric (e.g., water molecules) vibrates, dipole frictional heat is generated, and thus the dielectric may be heated. The object may be dried as the heated dielectric evaporates. The evaporated dielectric may be discharged to the outside of the drum 20 together with air supplied into the drum 20.

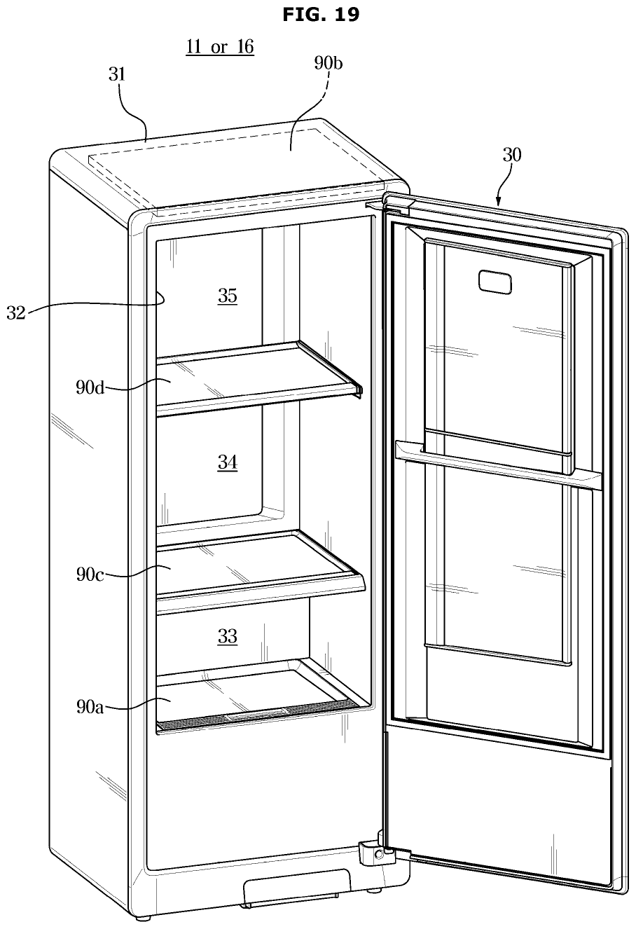

FIG. 19 illustrates an apparatus corresponding to a defrosting appliance or a refrigerator as a home appliance according to an embodiment of the disclosure.

Referring to FIG. 19, the home appliance 10 may be provided as the refrigerator 11 or the clothes treating apparatus 16 described in FIG. 1. The home appliance 10 may include cabinets 31 and 32 forming an exterior, and a door 30 rotatably coupled to the cabinets 31 and 32. The cabinets 31 and 32 may be provided in a rectangular parallelepiped shape with an open front. An opening may be formed on the open front of the cabinets 31 and 32. The door 30 may open and close the open front of the cabinets 31 and 32.

The cabinets 31 and 32 may include an outer cabinet 31 and an inner cabinet 32. The inner cabinet 32 may be disposed inside the outer cabinet 31. The cabinets 31 and 32 may form an accommodation space in which an object is accommodated.

A plurality of electrodes may be disposed in the cabinets 31 and 32. For example, a first electrode 90a, a second electrode 90b, a third electrode 90c, and a fourth electrode 90d may be positioned in the cabinets 31 and 32. The first electrode 90a, the second electrode 90b, the third electrode 90c, and the fourth electrode 90d may have a flat plate shape.

The first electrode 90a, the second electrode 90b, the third electrode 90c, and the fourth electrode 90d may be arranged parallel to each other and spaced apart. The first electrode 90a, the second electrode 90b, the third electrode 90c, and the fourth electrode 90d may be disposed horizontally with a bottom surface of the cabinets 31 and 32.

For example, the first electrode 90a may be positioned at a lower side of the cabinets 31 and 32. The first electrode 90a may be disposed on a bottom surface of the inner cabinet 32. The first electrode 90a may also be disposed between the outer cabinet 31 and the inner cabinet 32 at the lower side of the cabinets 31 and 32. The second electrode 90b may be positioned at an upper side of the cabinets 31 and 32. The second electrode 90b may be disposed on an upper surface of the inner cabinet 32. The second electrode 90b may also be disposed between the outer cabinet 31 and the inner cabinet 32 at the upper side of the cabinets 31 and 32. The first electrode 90a and the second electrode 90b may be fixed to the cabinets 31 and 32, or may be detachably provided.

The third electrode 90c and the fourth electrode 90d may be arranged between the first electrode 90a and the second electrode 90b. The third electrode 90c may be positioned below the fourth electrode 90d in a vertical direction. Each of the third electrode 90c and the fourth electrode 90d may be detachably provided in the cabinets 31 and 32.

As the third electrode 90c and the fourth electrode 90d are disposed in the cabinets 31 and 32, the inner space of the cabinets 31 and 32 may be divided into a plurality of accommodation spaces 33, 34, and 35. A first accommodation space 33 may be formed between the first electrode 90a and the third electrode 90c. A second accommodation space 34 may be formed between the third electrode 90c and the fourth electrode 90d. A third accommodation space 35 may be formed between the fourth electrode 90d and the second electrode 90b. At least one object may be placed in each of the plurality of accommodation spaces 33, 34, and 35. Because the electrodes 90a, 90b, 90c, and 90d may function as a shelf supporting an object, the electrodes may also be referred to as shelf electrodes.

The object may be placed on at least one of an upper surface of the first electrode 90a, an upper surface of the third electrode 90c, or an upper surface of the fourth electrode 90d.

Although four electrodes spaced apart in the vertical direction have been described, the number and position of the electrodes are not limited to those illustrated. For example, one of the third electrode 90c and the fourth electrode 90d may be omitted. In addition, three or more electrodes may be disposed between the first electrode 90a and the second electrode 90b. The number of accommodation spaces formed in the cabinets 31 and 32 may vary depending on the number and position of the electrodes disposed in the cabinets 31 and 32, and the size of the accommodation spaces may also vary.

The length, area, and/or thickness of each of the plurality of electrodes 90a, 90b, 90c, and 90d may vary depending on the design.

When RF power is applied to each of the plurality of electrodes 90a, 90b, 90c, and 90d, an electric field may be generated in a vertical direction in each of the plurality of accommodation spaces 33, 34, and 35. The electric field may vibrate a dielectric (e.g., water molecules) contained in the object. When the dielectric (e.g., water molecules) vibrates, dipole frictional heat is generated, and thus the dielectric may be heated. The object may be dried as the heated dielectric evaporates. The evaporated dielectric may be discharged to the outside of the home appliance 10.

A polarity of each of the plurality of electrodes 90a, 90b, 90c, and 90d may be determined according to the phase of RF power applied to each of the plurality of electrodes 90a, 90b, 90c, and 90d. An electric field may or may not be generated in each of the plurality of accommodation spaces 33, 34, and 35 according to the polarity of each of the plurality of electrodes 90a, 90b, 90c, and 90d. In other words, an electric field may be selectively generated in the plurality of accommodation spaces 33, 34, and 35. A magnitude of the electric field generated in each of the plurality of accommodation spaces 33, 34, and 35 may vary depending on a magnitude of the RF power applied to each of the plurality of electrodes 90a, 90b, 90c, and 90d.

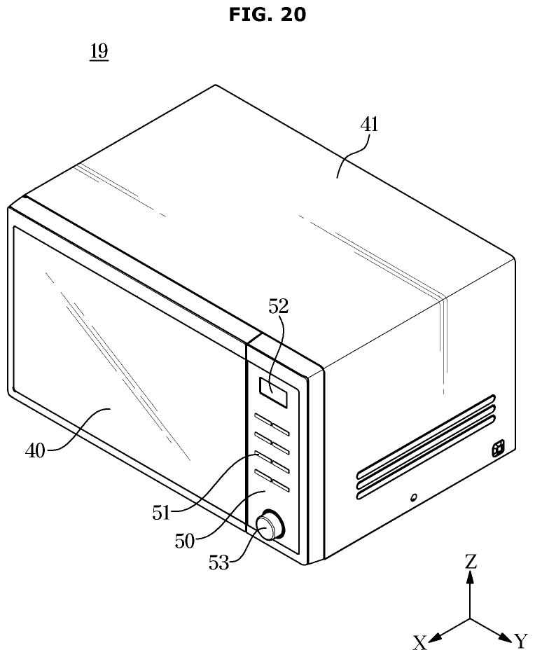

FIG. 20 illustrates an apparatus corresponding to a cooking appliance as a home appliance according to an embodiment of the disclosure.

Referring to FIG. 20, the home appliance 10 may be provided as the microwave oven 19 described in FIG. 1. The microwave oven 19 may also be referred to as a cooking appliance or a defrosting appliance. The home appliance 10 may include a housing 41 forming a chamber. The chamber may be formed inside the housing 41. An object may be placed in the chamber. The object may represent a cooking object that may be cooked by the home appliance 10.

A door 40 for opening or closing the chamber may be included. The door 40 may be rotatably coupled to the housing 41. At least a portion of the door 40 may be formed of a transparent material (e.g., transparent glass) or a translucent material (e.g., translucent glass). The door 40 may include heat-resistant glass. A user may see the inside of the chamber through the door 40.

The home appliance 10 may include a control panel 50. The control panel 50 may correspond to a user interface. The control panel 50 may be positioned on the housing 41. The control panel 50 may be disposed on one side of the door 40. The control panel 50 may include at least one of an input portion 51 for obtaining a user input, a display 52, or a door open button 53 for opening the door 40. The positions of the input portion 51, the display 52, and the door open button 53 are not limited to those illustrated, and may be provided at various positions.

The input portion 51 may transmit an electrical signal (voltage or current) corresponding to the user input to the controller 300. The input portion 51 may include various buttons and/or a dial. For example, the input portion 51 may include at least one of a power button for turning the home appliance 10 on or off, a start/stop button for starting or stopping a cooking operation, a cooking mode button for selecting a cooking mode, a temperature button for setting a cooking temperature, or a time button for setting a cooking time. Various buttons may be provided as physical buttons or touch buttons.

One of a plurality of cooking modes may be selected through the input portion 51. For example, the home appliance 10 may provide various cooking modes, such as an automatic cooking mode, a defrosting mode, and a warming mode. The home appliance 10 may perform cooking according to the selected cooking mode. The cooking mode may include cooking parameters such as cooking temperature and cooking time. Different cooking modes may be selected depending on the type, quantity, and/or size of the object.

According to an embodiment of the disclosure, a home appliance may include: a first electrode; a second electrode spaced apart from the first electrode; a radio frequency (RF) power supplier configured to apply an RF signal to the first electrode and the second electrode; a voltage-current sensor configured to detect an output voltage between the first electrode and the second electrode and an output current of the first electrode; an impedance matching circuit configured to perform impedance matching between an output side of the RF power supplier and the first electrode and the second electrode; a reactance regulator disposed between the first electrode and the impedance matching circuit; and a controller configured to: identify a load impedance between the first electrode and the second electrode based on the output voltage and the output current, determine a compensation reactance for removing a first reactance included in the load impedance, and control the reactance regulator to have a second reactance corresponding to the compensation reactance.

The controller may be configured to adjust the compensation reactance to maintain the first reactance of the load impedance within a preset error range while an object is heated.

The controller may be configured to: identify a current reactance of the reactance regulator, obtain a difference value between the current reactance and the determined compensation reactance, and determine the second reactance by adding the difference value to the current reactance or by subtracting the difference value from the current reactance.

The home appliance may further include a sensor switch configured to turn the voltage-current sensor on or off. The controller may be configured to control the sensor switch to allow the voltage-current sensor to detect the output voltage and the output current at preset time intervals.

The controller may be configured to obtain information about an object disposed between the first electrode and the second electrode through a user interface or a communication interface, and identify the load impedance corresponding to the information about the object from a lookup table stored in memory.

The information about the object may include at least one of a type, a size, a weight, or a number of the object.

The reactance regulator may include: a core; a coil configured to wind around the core; and a motor connected to one side of the coil. The controller may be configured to control the motor to adjust a length of the coil to allow the second reactance of the reactance regulator to correspond to the compensation reactance.

The reactance regulator may include: a core; a coil configured to wind around the core; and a motor connected to one side of the core. The controller may be configured to control the motor to adjust a position of the core to allow the second reactance of the reactance regulator to correspond to the compensation reactance.

The reactance regulator may include: a plurality of inductors arranged in series and in parallel; and a plurality of switches configured to connect the plurality of inductors. The controller may be configured to turn each of the plurality of switches on or off to allow the second reactance of the reactance regulator to correspond to the compensation reactance.

According to an embodiment of the disclosure, in a method for controlling a home appliance including a first electrode, a second electrode spaced apart from the first electrode, a radio frequency (RF) power supplier configured to apply an RF signal to the first electrode and the second electrode, an impedance matching circuit configured to perform impedance matching between an output side of the RF power supplier and the first electrode and the second electrode, a reactance regulator disposed between the first electrode and the impedance matching circuit, a voltage-current sensor, and a controller, the method may include: detecting, by the voltage-current sensor, an output voltage between the first electrode and the second electrode and an output current of the first electrode; identifying, by the controller, a load impedance between the first electrode and the second electrode based on the output voltage and the output current; determining, by the controller, a compensation reactance for removing a first reactance included in the load impedance; and controlling, by the controller, the reactance regulator to have a second reactance corresponding to the compensation reactance.

The determining of the compensation reactance may include: adjusting the compensation reactance to maintain the first reactance of the load impedance within a preset error range while an object is heated.

The method may further include: identifying a current reactance of the reactance regulator; obtaining a difference value between the current reactance and the determined compensation reactance; and determining the second reactance by adding the difference value to the current reactance or by subtracting the difference value from the current reactance.

The method may further include controlling a sensor switch configured to turn the voltage-current sensor on or off to allow the voltage-current sensor to detect the output voltage and the output current at preset time intervals.

The method may further include: obtaining information about an object disposed between the first electrode and the second electrode through a user interface or a communication interface; and identifying the load impedance corresponding to the information about the object from a lookup table stored in memory.

The reactance regulator may include: a core; a coil configured to wind around the core; and a motor connected to one side of the coil. The controlling of the reactance regulator may include controlling the motor to adjust a length of the coil to allow the second reactance of the reactance regulator to correspond to the compensation reactance.

The reactance regulator may include: a core; a coil configured to wind around the core; and a motor connected to one side of the core. The controlling of the reactance regulator may include controlling the motor to adjust a position of the core to allow the second reactance of the reactance regulator to correspond to the compensation reactance.

The reactance regulator may include: a plurality of inductors arranged in series and in parallel; and a plurality of switches configured to connect the plurality of inductors. The controlling of the reactance regulator may include turning each of the plurality of switches on or off to allow the second reactance of the reactance regulator to correspond to the compensation reactance.

According to the disclosure, the home appliance and the method for controlling the same may suppress a decrease in heating efficiency of an object due to an empty space between two electrodes by controlling a reactance regulator disposed between the electrodes and an impedance matching circuit.

According to the disclosure, the home appliance and the method for controlling the same may transmit a maximum active power to an object by reducing and/or removing a reactance component of a load impedance without physically adjusting a distance between two electrodes.

According to the disclosure, the home appliance and the method for controlling the same may relatively accurately measure an actual impedance of an object using a reactance regulator disposed between electrodes and an impedance matching circuit.

According to the disclosure, the home appliance and the method for controlling the same may reduce a voltage and a current applied to an electrode for heating an object by reducing and/or removing a reactance component of a load impedance. Accordingly, power consumption may be reduced and the stability of the circuit system may be improved.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments.

The machine-readable recording medium may be provided in the form of a non-transitory storage medium. When a storage medium is referred to as “non-transitory”, it may be understood that the storage medium is tangible and does not include a signal (e.g., an electromagnetic wave), but rather that data is semi-permanently or temporarily stored in the storage medium. For example, a “non-transitory storage medium” may include a buffer in which data is temporarily stored.

The method according to the various embodiments disclosed herein may be provided in a computer program product. The computer program product may be traded between a seller and a buyer as a product. The computer program product may be distributed in the form of a machine-readable recording medium (e.g., compact disc read only memory (CD-ROM)), or may be distributed (e.g., download or upload) through an application store (e.g., Play Store™) online or directly between two user devices (e.g., smartphones). In the case of online distribution, at least a portion of the computer program product (e.g., downloadable app) may be stored at least semi-permanently or may be temporarily generated in a recording medium, such as memory of a server of a manufacturer, a server of an application store, or a relay server.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A home appliance, comprising:
a first electrode;
a second electrode spaced apart from the first electrode;
a radio frequency (RF) power supplier configured to apply an RF signal to the first electrode and the second electrode;
a voltage-current sensor configured to detect an output voltage between the first electrode and the second electrode and an output current of the first electrode;
an impedance matching circuit configured to perform impedance matching between an output side of the RF power supplier and the first electrode and the second electrode;
a reactance regulator disposed between the first electrode and the impedance matching circuit; and
a controller configured to:
identify a load impedance between the first electrode and the second electrode based on the output voltage and the output current,
determine a compensation reactance for removing a first reactance included in the load impedance, and
control the reactance regulator to have a second reactance corresponding to the compensation reactance.

2. The home appliance of claim 1, wherein the controller is further configured to adjust the compensation reactance to maintain the first reactance of the load impedance within a preset error range while an object is heated.

3. The home appliance of claim 1, wherein the controller is further configured to:
identify a current reactance of the reactance regulator;
obtain a difference value between the current reactance and the determined compensation reactance; and
determine the second reactance by adding the difference value to the current reactance or by subtracting the difference value from the current reactance.

4. The home appliance of claim 1, further comprising:
a sensor switch configured to turn the voltage-current sensor on or off,
wherein the controller is further configured to control the sensor switch to allow the voltage-current sensor to detect the output voltage and the output current at preset time intervals.

5. The home appliance of claim 1, wherein the controller is further configured to:
obtain information about an object disposed between the first electrode and the second electrode through a user interface or a communication interface; and
identify the load impedance corresponding to the information about the object from a lookup table stored in memory.

6. The home appliance of claim 5, wherein the information about the object includes at least one of a type, a size, a weight, or a number of the object.

7. The home appliance of claim 1, wherein the reactance regulator comprises:
a core;
a coil configured to wind around the core; and
a motor connected to one side of the coil,
wherein the controller is further configured to control the motor to adjust a length of the coil to allow the second reactance of the reactance regulator to correspond to the compensation reactance.

8. The home appliance of claim 1, wherein the reactance regulator comprises:
a core;
a coil configured to wind around the core; and
a motor connected to one side of the core,
wherein the controller is further configured to control the motor to adjust a position of the core to allow the second reactance of the reactance regulator to correspond to the compensation reactance.

9. The home appliance of claim 1, wherein the reactance regulator comprises:
a plurality of inductors arranged in series and in parallel; and
a plurality of switches configured to connect the plurality of inductors,
wherein the controller is further configured to turn each of the plurality of switches on or off to allow the second reactance of the reactance regulator to correspond to the compensation reactance.

10. A method for controlling a home appliance comprising a first electrode, a second electrode spaced apart from the first electrode, a radio frequency (RF) power supplier configured to apply an RF signal to the first electrode and the second electrode, an impedance matching circuit configured to perform impedance matching between an output side of the RF power supplier and the first electrode and the second electrode, a reactance regulator disposed between the first electrode and the impedance matching circuit, a voltage-current sensor, and a controller, the method comprising:
detecting, by the voltage-current sensor, an output voltage between the first electrode and the second electrode and an output current of the first electrode;
identifying, by the controller, a load impedance between the first electrode and the second electrode based on the output voltage and the output current;
determining, by the controller, a compensation reactance for removing a first reactance included in the load impedance; and
controlling, by the controller, the reactance regulator to have a second reactance corresponding to the compensation reactance.

11. The method of claim 10, wherein the determining of the compensation reactance comprises:
adjusting the compensation reactance to maintain the first reactance of the load impedance within a preset error range while an object is heated.

12. The method of claim 10, further comprising:
identifying a current reactance of the reactance regulator;
obtaining a difference value between the current reactance and the determined compensation reactance; and
determining the second reactance by adding the difference value to the current reactance or by subtracting the difference value from the current reactance.

13. The method of claim 10, further comprising:
controlling a sensor switch configured to turn the voltage-current sensor on or off to allow the voltage-current sensor to detect the output voltage and the output current at preset time intervals.

14. The method of claim 10, further comprising:
obtaining information about an object disposed between the first electrode and the second electrode through a user interface or a communication interface; and
identifying the load impedance corresponding to the information about the object from a lookup table stored in memory.

15. The method of claim 14, wherein the information about the object includes at least one of a type, a size, a weight, or a number of the object.

16. The method of claim 14, further comprising performing matching between an output impedance of the RF power supplier and the load impedance after removing a reactance of the load impedance.

17. The method of claim 16, wherein, when the impedance matching is represented on a Smith chart, a resonance is reached first from a starting point corresponding to the load impedance as reactance removal of the load impedance is performed first by the reactance regulator.

18. One or more non-transitory computer-readable storage media storing one or more computer programs including computer-executable instructions that, when executed by one or more processors of a controller of a home appliance individually or collectively, cause the home appliance to perform operations, the home appliance comprising a first electrode, a second electrode spaced apart from the first electrode, a radio frequency (RF) power supplier configured to apply an RF signal to the first electrode and the second electrode, an impedance matching circuit configured to perform impedance matching between an output side of the RF power supplier and the first electrode and the second electrode, a reactance regulator disposed between the first electrode and the impedance matching circuit, and a voltage-current sensor, the operations comprising:
detecting, by the voltage-current sensor, an output voltage between the first electrode and the second electrode and an output current of the first electrode;
identifying, by the controller, a load impedance between the first electrode and the second electrode based on the output voltage and the output current;
determining, by the controller, a compensation reactance for removing a first reactance included in the load impedance; and
controlling, by the controller, the reactance regulator to have a second reactance corresponding to the compensation reactance.

19. The one or more non-transitory computer-readable storage media of claim 18, wherein the determining of the compensation reactance comprises:
adjusting the compensation reactance to maintain the first reactance of the load impedance within a preset error range while an object is heated.

20. The one or more non-transitory computer-readable storage media of claim 18, the operations further comprising:
identifying a current reactance of the reactance regulator;
obtaining a difference value between the current reactance and the determined compensation reactance; and
determining the second reactance by adding the difference value to the current reactance or by subtracting the difference value from the current reactance.
